(19) United States
(12) Patent Application Publication
(10) Pub. No.: US 2025/0259619 A1
(43) Pub. Date: Aug. 14, 2025

(54) LOW LATENCY GENERATIVE ARTIFICIAL INTELLIGENCE AUDIO PIPELINE

(71) Applicant: META PLATFORMS, INC., Menlo Park, CA (US)

(72) Inventors: Ishan Sanjay Khot, Seattle, WA (US); David Yan, Toronto (CA); Shreyas Narendra Basarge, Mountain View, CA (US); Ankush Bagotra, Milpitas, CA (US); Priyanshu Kumar Singh, Santa Clara, CA (US); Yue Zhou Gao, Issaquah, WA (US); John Unterholzner, Rochester, MN (US); Yuchen Huang, Sunnyvale, CA (US); Qiuren Fang, Sunnyvale, CA (US); Bharath Venkataramani, Sunnyvale, CA (US); Licheng Yu, Mountain View, CA (US); Chenyun Zhang, Mountain View, CA (US); Amy Lawson Bearman, Emerald Hills, CA (US); Luxin Zhang, Cambridge, MA (US); Anmol Kalia, Redwood City, CA (US); Dingkang Wang, Fairfax, VA (US); Elliot Blanchard, Brooklyn, NY (US); Ankit Rajesh Ramchandani, Menlo Park, CA (US); Albert Pumarola Peris, Kilchberg (CH); Miao Liu, Mountain View, CA (US); Edgar Schoenfeld, Zürich (CH); Krishna Narni, Aberdeen, NJ (US); Yaqiao Luo, Toronto (CA)

(21) Appl. No.: 19/001,278

(22) Filed: Dec. 24, 2024

Related U.S. Application Data
(60) Provisional application No. 63/556,348, filed on Feb. 21, 2024.
(60) Provisional application No. 63/551,325, filed on Feb. 8, 2024.

(51) Int. Cl. G10L 13/08; G06T 11/00; G10L 15/02; G10L 15/06

(52) U.S. Cl. CPC G10L 13/08; G06T 11/00; G10L 15/063; G10L 2015/025

(57) ABSTRACT

Methods and systems are described for audio pipelines between a user and a machine learning (ML) model. The method involves obtaining digital audio data associated with an audio signal from a user's equipment. This data is then analyzed using a trained ML model, which includes one or more neural networks. The ML model determines an indication related to the digital audio data, which can be a prediction of the ending of one or more portions of the data, an intention behind the data, a key term within the data, an action to take based on the data, or the context associated with the data. Based on the determined indication, a response is generated and subsequently transmitted back to the user's equipment.

### CROSS-REFERENCE TO RELATED APPLICATIONS

This application claims the benefit of priority of U.S. Provisional Application No. 63/556,348 filed Feb. 21, 2024 entitled, “Low Latency Generative Artificial Intelligence Audio Pipeline,” and U.S. Provisional Application No. 63/551,325 filed Feb. 8, 2024 entitled, “Latent Diffusion Video Modeling for Animated Sticker Generation,” the contents of which is incorporated by reference in their entireties.

### TECHNOLOGICAL FIELD

Examples of the present disclosure relate generally to methods, apparatuses, and computer program products for generative artificial intelligence (AI) for audio pathways.

### BACKGROUND

Many company communication services (e.g., audio services such as a call or the like) may use bots to answer calls from users and/or direct users to the appropriate department associated with the company. Generally a user may experience latencies in obtaining a response from the bot. The latency in response may be due to speech or audio signals being transferred to text by the bot. The latency may disrupt the flow of conversation and hurt the user experience. What is desired is a reliable method to experience a more fluent conversational pattern between a bot and a user.

Text-to-video generation aims to translate a descriptive text string to a video or animation. One natural application of such technology is with animated stickers in social media applications. They may include for example a display of moods, feelings, or other expressions within an environment. Many text-to-video models face challenges with the complexity of parsing individual parts to efficiently generate high-quality, accurate results in a specialized domain. For instance, current models may experience visual clarity issues such as lacking sharpness, smooth movement and/or relevance to the message or feeling intended to be conveyed by a user.

### BRIEF SUMMARY

One aspect of the present application is directed to a method of employing generative AI techniques. The method involves obtaining digital audio data associated with an audio signal from a user's equipment. This data is analyzed using a trained machine learning (ML) model, which includes one or more neural networks. The ML model determines an indication related to the digital audio data, which can be a prediction of the ending of one or more portions of the data, an intention behind the data, a key term within the data, an action to take based on the data, or the context associated with the data. Based on the determined indication, a response is generated and subsequently transmitted back to the user's equipment.

Another aspect of the present application is directed to method of employing generative AI techniques. The method involves training a video generation ML model using a video dataset associated with graphical stickers and employing one or more conditioning signals. The trained video generation ML model is subsequently finetuned by applying feedback based on the quality of motion and content to its output. Finally, the trained and finetuned video generation ML model analyzes a text string associated with a first graphical sticker input to generate a second graphical sticker.

Additional advantages will be set forth in part in the description which follows or may be learned by practice. The advantages will be realized and attainted by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1A illustrates an exemplary network environment in accordance with the present application.

FIG. 1B illustrates an example head mounted display (HMD) in accordance with the present application.

FIG. 1C illustrates an example block diagram of an HMD device in accordance with the present application.

FIG. 1D illustrates a machine learning (ML) and training model in accordance with the present application.

FIG. 2 illustrates an example data pipeline associated with a voice over internet protocol (VoIP) in accordance with an aspect of the present application.

FIG. 3A illustrates an example method of a predictive machine learning process associated with a data pipeline for VoIP, in accordance with an aspect of the present application.

FIG. 3B illustrates an example sequence diagram associated with FIG. 3A in accordance with an aspect of the present application.

FIG. 3C illustrates an example hierarchical machine learning process associated with a data pipeline for VoIP in accordance with an aspect of the present application.

FIG. 4 illustrates an example latency masking process associated with a data pipeline for VoIP in accordance with an aspect of the present application.

FIG. 5A illustrates an alternate example data pipeline associated with a VoIP including a phoneme adaptive machine learning process in accordance with an aspect of the present application.

FIG. 5B illustrates an example of a phoneme adaptive machine learning process associated with a data pipeline for VoIP in accordance with an aspect of the present application.

FIG. 6 illustrates an example use case of a generative artificial intelligence audio pipeline in accordance with an aspect of the present application.

FIG. 7 illustrates an example flowchart of the audio pipeline in accordance with an aspect of the present application.

FIG. 8 illustrates example animated stickers generated from models in accordance with an aspect of the present application.

FIG. 9 illustrates an example system architecture including a latent diffusion model (LDM) with additional temporal layers in accordance with an aspect of the present application.

FIG. 10 illustrates an example annotation interface, in accordance with an aspect of the present application.

FIG. 11 illustrates an example architecture for finetuning models, in accordance with aspects of the present disclosure.

FIG. 12 illustrates examples of finetuning models versus general-purpose video models, in accordance with aspects of the present disclosure.

FIG. 13 illustrates differences between first frame conditions versus middle frame conditioning, in accordance with aspects of the present disclosure.

FIG. 14 illustrates examples of animated stickers generated using finetuned models, in accordance with aspects of the present disclosure.

FIG. 15 illustrates a flowchart for an example video generation system, in accordance with aspects of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the subject technology will now be described more fully hereinafter with reference to the accompanying drawings, in which some, but not all examples of the subject technology are shown. Indeed, various examples of the subject technology may be embodied in many different forms and should not be construed as limited to the examples set forth herein. Like reference numerals refer to like elements throughout.

As used herein, the terms “data,” “content,” “information,” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” (app) may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of augmented/virtual/mixed reality.

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

It is to be understood that the methods and systems described herein are not limited to specific methods, specific components, or to particular implementations. It is also to be understood that the terminology used herein is for the purpose of describing particular embodiments only and is not intended to be limiting.

The subject technology describes systems and/or methods employing generative AI for audio pipelines associated with voice over internet communications between a user and a bot (e.g., an artificial intelligence system) via an electronic device (e.g., head mounted displays, smartphones, tablets, smartwatches, or any electronic device).

In various examples, systems and/or methods may receive, via a device associated with a user, a portion of an audio signal associated with speech spoken by a person. A text associated with the portion of the audio signal may be determined via a ML model. The ML model may predict a list of possible responses associated with the text. The ML model may detect that the user has stopped speaking. Based on detecting the user has stopped sending audio signals, the ML model may compare the received audio signal to the list of possible responses. The ML model may convert a matching response of the list of possible responses to the audio signal, wherein the audio signal may be conveyed to the user as speech.

In various examples, systems and/or methods may receive, via a device associated with a user, an audio signal associated with speech spoken by a person. A text associated with the audio signal may be determined via a first ML model, wherein the first ML model may determine an intent associated with the text. A second ML model may extract a known term from the text received via the first ML model. A third ML model may perform actions associated with the received text, the intent, and the known term determined via the second machine learning model and third machine learning model, respectively. A fourth ML model may synthesize a response to the text associated with the received audio signal.

In various examples, systems and/or methods may receive, via a device associated with a user, an audio signal associated with speech spoken by a person. The audio signal may be analyzed via a first ML model, determining a number of phonemes associated with the audio signal. The number of phonemes may be received via a second ML model, wherein the second ML model may comprise a number of adaptive layers configured to assess the phonemes received. The second ML model may determine weights associated with the adaptive layers via backpropagation. A response to the audio signal may be sent to the user.

In various examples, systems and/or methods may receive, via a device associated with a user, an audio signal associated with speech spoken by a person. The audio signal may be analyzed via a ML model. The ML model may send a masking phase to mask the latency associated with generating a response. A response may be sent via the machine learning model to the user.

The one or more ML models may be trained based on statistical models to analyze vast amounts of data, learning patterns and connections between words or phrases, natural language patterns, or previously selected replies associated with the user. In various examples, the ML model may utilize one or more neural networks to develop associations between received audio signals and the associated text, natural language patterns, previously selected replies. One of the number of responses may be generated and provided to a user via a device (e.g., HMD, smartphones, tablets, smartwatches, computing device, communication device, or the like). The response may be in the form of an audio signal, generated image, generated video, generated avatar, text, or any combination thereof.

According to a further aspect of the subject technology, a text-and-image-to-video latent diffusion model (LDM) may be employed to generate an animation conditioned on a text prompt and static sticker image. Various examples may use pretrained weights in a text-to-image (T2I) model in several stages of pretraining for initializing spatio-temporal layers, followed by in-domain finetuning, to consistently generate videos with high-quality motion that is interesting, and relevant to the subject and to the target domain.

In various examples, both noisy and high-quality, in-domain, prompt video pairs may be collected as training data. The training data may be employed in a human-in-the-loop (HITL) finetuning strategy. This strategy enables specifically targeted improvements to motion quality while maintaining a style from the static image. With inference optimizations, the model is able to generate, for example, a high-quality eight-frame video in under one second.

In further embodiments, video generation systems and/or methods may be configured to train a video generation model using a first video set and a dataset associated with a first domain. The video generation model is a spatio-temporal LDM employed to generate an output in at least one domain, finetune the video generation model based on user input indicative of a review of a dataset associated with the first domain, and apply the video generation model to analyze a text string and generate an associated output within the first domain.

According to another aspect, the subject technology may be directed to video generation models for generating static stickers, animated stickers or similar features. Generated videos may be variable lengths (e.g., under 3 seconds), and have variable framerates, depending, for example, on whether keyframes are interpolated in time.

Animated stickers may enhance visual communication, social expression, and conversations through digital interactions. Animated stickers may include one or more digital graphics, similar to a GIF, that includes movement of one or more icons and dynamic elements to create motion and convey actions, emotions, and other expressions. Social media and other communication platforms (e.g., text messaging) may utilize animated stickers to provide additional entertaining, expressive, and creative options for users to convey, for example, thoughts, emotions, reactions, subjects, and personality. Some animated stickers loop at least one graphical element to provide a continuous animation, and feature various characters, emojis, images, shapes, colors, and graphical designs.

### General Architecture

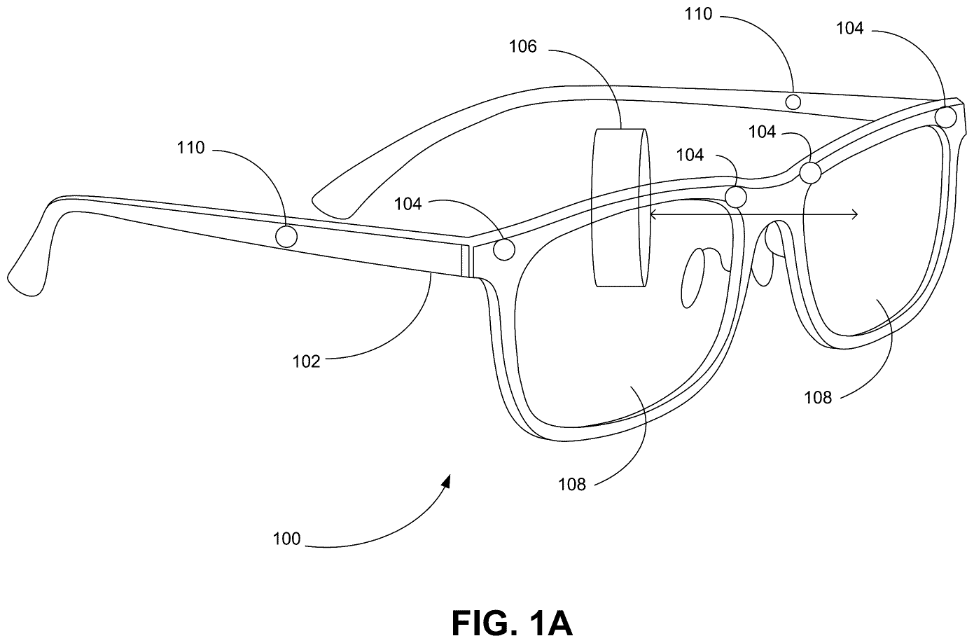

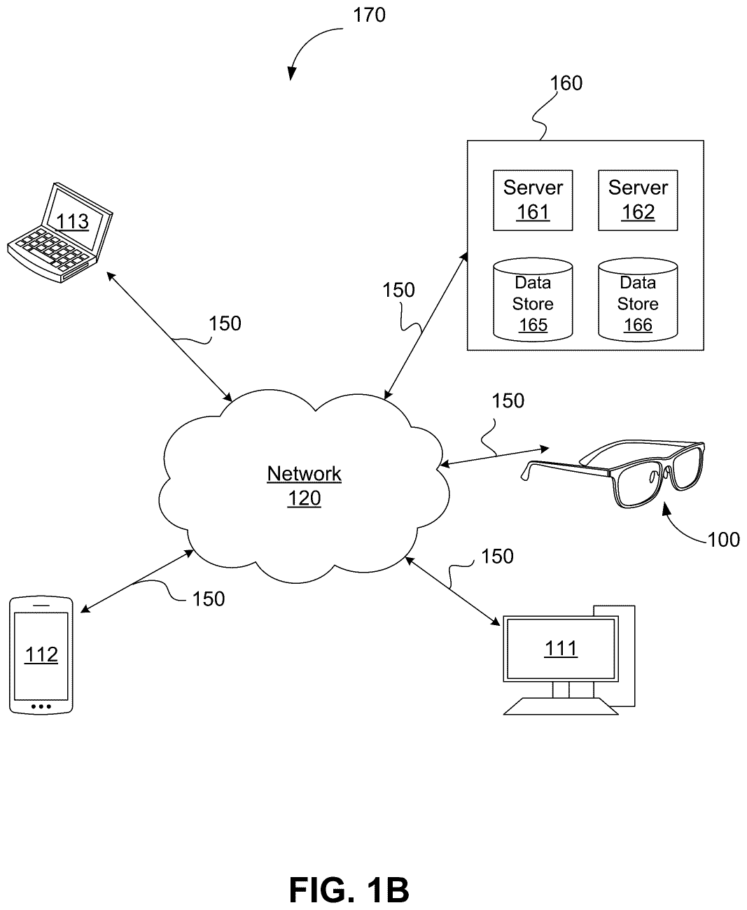

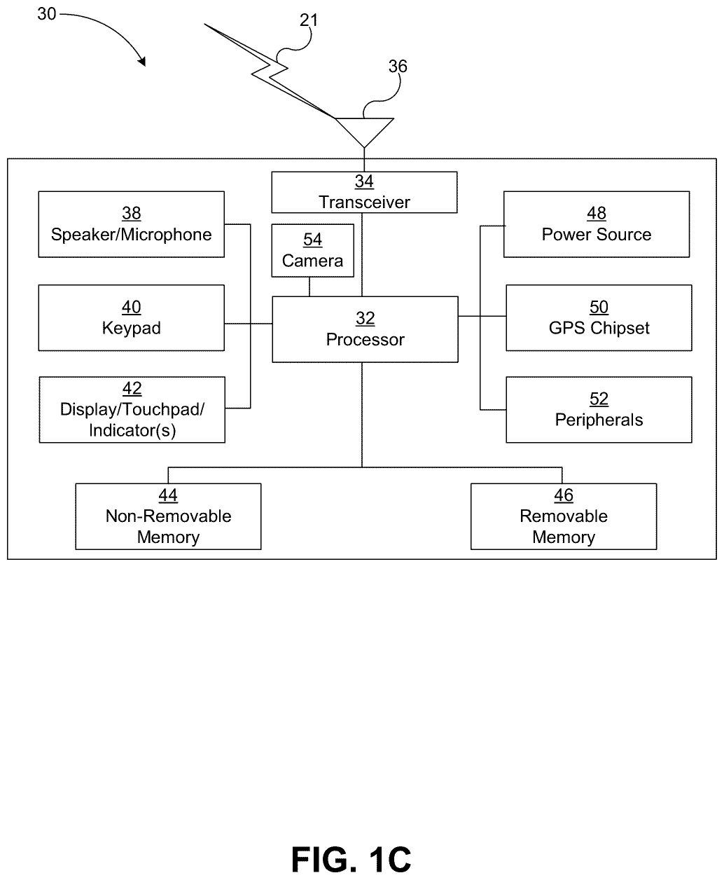

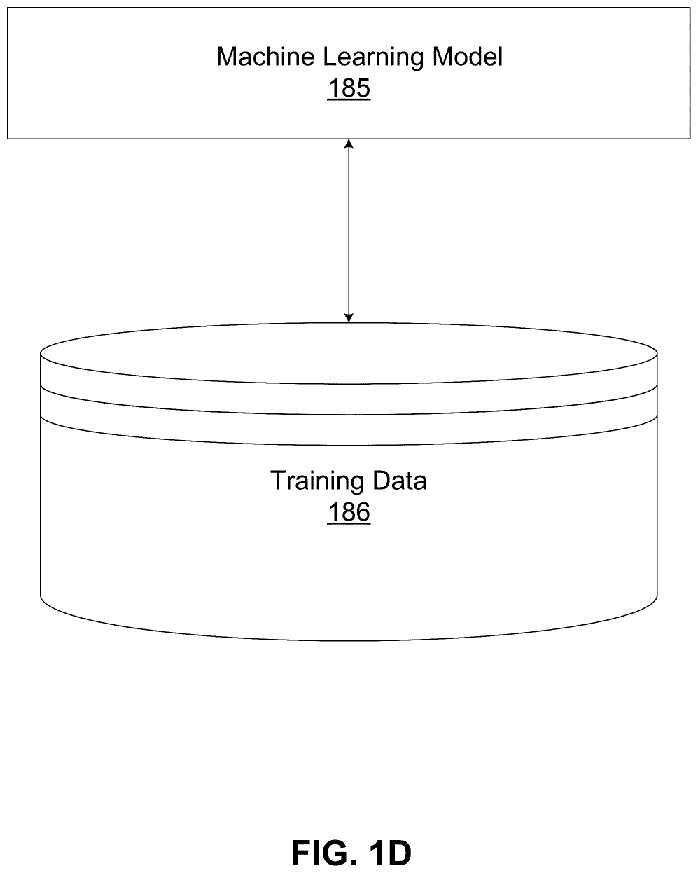

FIG. 1A illustrates an example HMD 100 associated with artificial reality content. HMD 100 may include frame 102 (e.g., an eyeglasses frame), a camera 104, a display 108, and an audio device 110 (e.g., speakers/microphone). Display 108 may be configured to direct images to a surface 106 (e.g., a user's eye or another structure). In some examples, HMD 100 may be implemented in the form of augmented-reality glasses. Accordingly, display 108 may be at least partially transparent to visible light to allow the user to view a real-world environment through the display 108. The audio device 110 (e.g., speakers/microphones) that may provide audio associated with augmented-reality content to users and capture audio signals.

Tracking of surface 106 may be beneficial for graphics rendering or user peripheral input. In many systems, HMD 100 design may include one or more cameras 104 (e.g., a front facing camera(s) away from a user or a rear facing camera(s) towards a user. Camera 104 may track movement (e.g., gaze) of eye or line of sight associated with the user. HMD 100 may include an eye tracking system to track the vergence movement of primary user 120. Camera 104 may capture images or videos of an area, or capture video or images associated with surface 106 depending on the directionality and view of camera 104. In examples where camera 104 is rear facing towards a user, camera 104 may capture images or videos associated with surface 106. In examples where camera 104 is front facing away from a user, camera 104 may capture images or videos of an area. HMD 100 may be designed to have both front facing and rear facing cameras (e.g., camera 104). There may be multiple cameras 104 that may be used to detect the reflection off of surface 106 or other movements (e.g., glint or any other suitable characteristic). Camera 104 may be located on frame 102 in different positions. Camera 104 may be located along a width of a section of frame 102. In some other examples, the camera 104 may be arranged on one side of frame 102 (e.g., a side of frame 102 nearest to the eye). Alternatively, in some examples, the camera 104 may be located on display 108. In some examples, camera 104 may be sensors or a combination of cameras and sensors to track eye (e.g., surface 106) of a user.

Audio device 110 may be located on frame 102 in different positions or any other configuration such as but not limiting to headphone(s) communicatively connected to HMD 100, a peripheral device, or the like. Audio device 110 may be located along a width of a section of frame 102. In some other examples, the audio device may be arranged on sides of frame 102 (e.g., a side of frame 102 nearest to the ear). In some examples, audio device 110 may be sensors or a combination of speakers, microphones, and sensors to capture and produce sound associated with a user.

Reference is now made to FIG. 1B, which is a block diagram of a system according to examples. As shown in FIG. 1B, the system 170 may include one or more communication devices 100, 111, 112, and 113 and a network device 160. Additionally, the system 170 may include any suitable network such as, for example, network 120. As an example and not by way of limitation, one or more portions of network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 120 may include one or more networks 120.

Links 150 may connect the communication devices 100, 111, 112, and 113 to network 120, network device 160 and/or to each other. This disclosure contemplates any suitable links 150. In some examples, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some examples, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 170. One or more first links 150 may differ in one or more respects from one or more second links 150.

In some examples, communication devices 100, 111, 112, and 113 may be electronic devices including hardware, software, or embedded logic components or a combination of two or more such components and capable of carrying out the appropriate functionalities implemented or supported by the communication devices 100, 111, 112, and 113. As an example, and not by way of limitation, the communication devices 100, 111, 112, and 113 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 100, 111, 112, and 113, may enable one or more users to access network 120. The communication devices 100, 111, 112, and 113 may enable a user(s) to communicate with other users at other communication devices 100, 111, 112, and 113.

Network device 160 may be accessed by the other components of system 170 either directly or via network 120. As an example, and not by way of limitation, communication devices 100, 111, 112, and 113 may access network device 160 using a web browser or a native application associated with network device 160 (e.g., a mobile social-networking application, a messaging application, another suitable application, or any combination thereof) either directly or via network 120. In particular examples, network device 160 may include one or more servers 161, 162. Each server 161, 162 may be a unitary server or a distributed server spanning multiple computers or multiple datacenters. Servers 161, 162 may be of various types, such as, for example and without limitation, web server, news server, mail server, message server, advertising server, file server, application server, exchange server, database server, proxy server, another server suitable for performing functions or processes described herein, or any combination thereof. In particular examples, each server 161, 162 may include hardware, software, or embedded logic components or a combination of two or more such components for carrying out the appropriate functionalities implemented and/or supported by server 161, 162. In particular examples, network device 160 may include one or more data stores 165, 166. Data stores 165, 166 may be used to store various types of information. In particular examples, the information stored in data stores 165, 166 may be organized according to specific data structures. In particular examples, each data store 165, 166 may be a relational, columnar, correlation, or other suitable database. Although this disclosure describes or illustrates particular types of databases, this disclosure contemplates any suitable types of databases. Particular examples may provide interfaces that enable communication devices 100, 111, 112, and 113 and/or another system (e.g., a third-party system) to manage, retrieve, modify, add, or delete, the information stored in data store 165, 166.

Network device 160 may provide users of the system 170 the ability to communicate and interact with other users. In particular examples, network device 160 may provide users with the ability to take actions on various types of items or objects, supported by network device 160. In particular examples, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

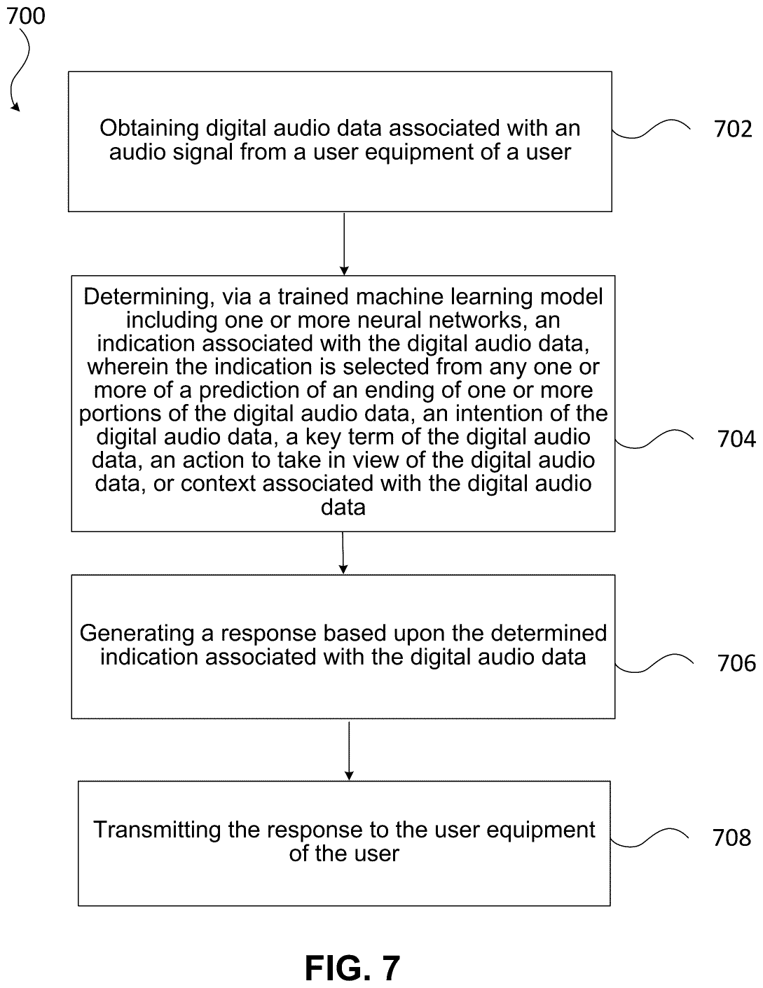

It should be pointed out that although FIG. 7 shows one network device 160 and four communication devices 100, 111, 112, and 113 any suitable number of network devices 160 and communication devices 100, 111, 112, and 113 may be part of the system of FIG. 1B without departing from the spirit and scope of the present disclosure.

FIG. 1C illustrates a block diagram of an example hardware/software architecture of user equipment (UE) 30. As shown in FIG. 1C, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an example, the camera 54 is a smart camera configured to sense images appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

FIG. 1D illustrates a machine learning and training model, in accordance with an example of the present disclosure. The framework 180 associated with the machine learning model may be hosted remotely. Alternatively, the framework 180 may reside within the HMD 100 shown in FIG. 1A, or be processed by an electronic device (e.g., head mounted displays, smartphones, tablets, smartwatches, or any electronic device). The machine learning model 185 may be operably coupled to the stored training data 186 in a memory or database (e.g., ROM 93, RAM 82). In some other examples, the machine learning model 185 may be associated with other operations. The machine learning model 185 may be implemented by one or more machine learning models(s) and/or another device (e.g., a server and/or a computing system).

### Low Latency

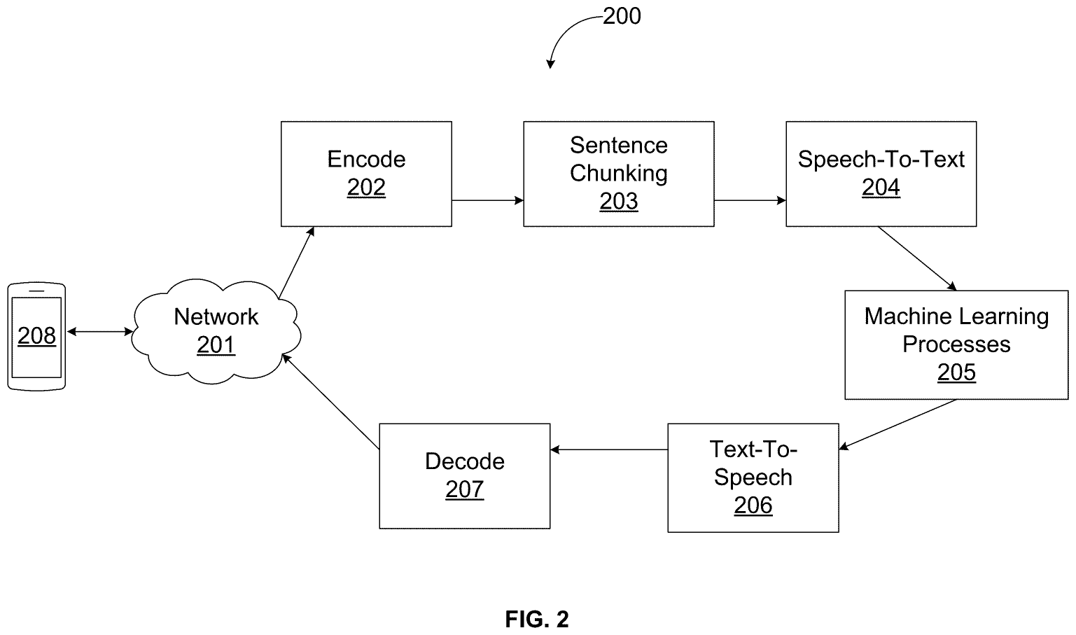

According to an embodiment, FIG. 2 illustrates an example data pipeline 200 associated with a voice over internet protocol (VoIP). The data pipeline 200 may comprise a network 201. It is contemplated that network 201 may be configured to be in communication with a server where the following processes may occur. Such processes may include but not limited to encoding 202, sentence chunking 203, speech-to-text 204, machine learning (ML) processes 205, text-to-speech 206, and/or decoding 207.

Although FIG. 2 is illustrated in a specific manner with a specific user device, it is contemplated that any user device 208 connected to network 201 may be able to perform the processes of associated with VoIP. In some alternate examples, some of the processes of data pipeline 200 may be performed on a user device 208. It is contemplated that the processes of data pipeline 200 may be performed solely on one device or distributed over multiple devices. This disclosure contemplates any suitable network 201. As an example and not by way of limitation, one or more portions of network 201 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 201 may include one or more networks 201. Although not illustrated for simplicity, the network 201 may be communicatively linked to a server associated with an entity (e.g., insurance company, banking organization, health plan, social media platform, third media application, or the like).

In an example, device 208 may be associated with an individual (e.g., a user). In particular examples, device 208 may attempt to initiate a conversation or a call to an entity. In particular examples, one or more users may user one or more devices (e.g., device 208) to send data to, or receive data from data pipeline 200 to which may be located on a server, device (e.g., device 208) or the like. In particular examples, device 208 may be an electronic device including hardware, software, or embedded logic components or a combination of two or more such components and capable of carrying out the appropriate functionalities implemented or supported by the device 208. As an example and not by way of limitation, device 208 may be a computer system such as for example, a desktop computer, notebook or laptop computer, netbook, a tablet computer (e.g., smart tablet), e-book reader, global positioning system (GPS) device, personal digital assistant (PDA), handheld electronic device, cellular telephone, smartphone, augmented/virtual reality device, other suitable electronic device, or any suitable combination thereof. This disclosure contemplates any suitable device (e.g., device 208). A device 208 may enable a user to access network 201. In some examples, device 208 may enable a user(s) to communicate with a bot associated with an entity. In particular examples, device 208 may comprise a number of sensors (e.g., microphones) to capture data (e.g., audio signals) and information necessary to provide speech or WAV files associated with speech of a user to network 201, wherein network 201 may be communicatively linked to an entity. In particular examples, device 208 may be configured to send an audio signal associated with the voice of a user via network 201 and receive a content item (e.g., a generated audio signal, video, image, text, or any combination thereof) in response to the sent audio signal.

A user device (e.g., device 208) may receive an audio signal (e.g., data) via a MEMS microphone, the received audio signal may then be sent to network 201, wherein the network 201 may be associated to a server where the audio signal may be processed. In some examples, the device 208 may send audio signals continuously to network 201. At the server, the audio signal may undergo a series of processes to convert the audio data to text, to determine a response based on the text associated with the received audio signal, and to convert the response to an audio signal such that the response may be heard by a user associated with the device. The audio signal (e.g., audio data) may undergo encoding (e.g., encode 202), where the audio signal may be converted from analog audio signals to digital audio data. The received audio signal may be an analog signal in the form of a waveform, whereas digital signals (e.g., digital audio data) may be in binary form. The audio signal received via the device 208 may undergo encoding 202 such that the audio signal may be interpreted by a computer, a processor, a machine learning model (e.g., machine learning processes 205), or the like. At encode 202, the analog audio signal may be converted to digital audio data, wherein the analog audio signal may be converted to any number of digital data formats such as but not limited to MPEG audio layer 3 (MP3), waveform audio file format (WAV), audio interchange file format (AIFF), OGG, or the like.

At the sentence chunking step 203, the now digital audio data may be broken down into a number of segments or sentences. At speech-to-text 204, each segmented digital audio data may be assessed and matched to a corresponding phoneme, wherein a phoneme may refer to elements of human speech used to create meaningful expressions. In response to matching the phonemes, the server may then locate the respective grapheme for each of the matched phonemes, where graphemes are words, phrases, or symbols that correspond to linguistic phonetics. The server may then analyze the context of the speech to establish relationships between the spoken words (e.g., audio signal) outputting a text associated with the digital audio data. The text may then be assessed to determine a response via one or more machine learning systems (e.g., machine learning processes 205). The result of the machine learning processes 205 may be a response text, wherein the response text may be based on a context of the received audio signal. The context of the digital audio data may be determined via the machine learning processes 205. In an example, the machine learning process 205, may comprise one or more machine learning models, where the one or more machine learning models may be any large language model. The response text may then undergo text-to-speech 206, where the response text (e.g., a response digital signal) may be converted to a number of response phonemes associated with the response text. Each of the number of response phonemes may comprise a specific duration and latent features of the response digital signal. The number of phonemes of the response digital signal may then be associated with an artificial voice (e.g., an AI bot voice). As a result, the response digital data may be decoded, via decode 207, and the latent features of the number of phonemes may be processed to determine and one or more of energy, duration, and pitch. In some examples, the decoder may convert the response digital data to acoustic features which are then converted to speech waveforms (e.g., a response analog audio signal) associated with the AI bot voice. The response analog audio signal may be sent to a loudspeaker (e.g., speaker) of device 208 to allow the user to hear the response determined via the machine learning processes 205.

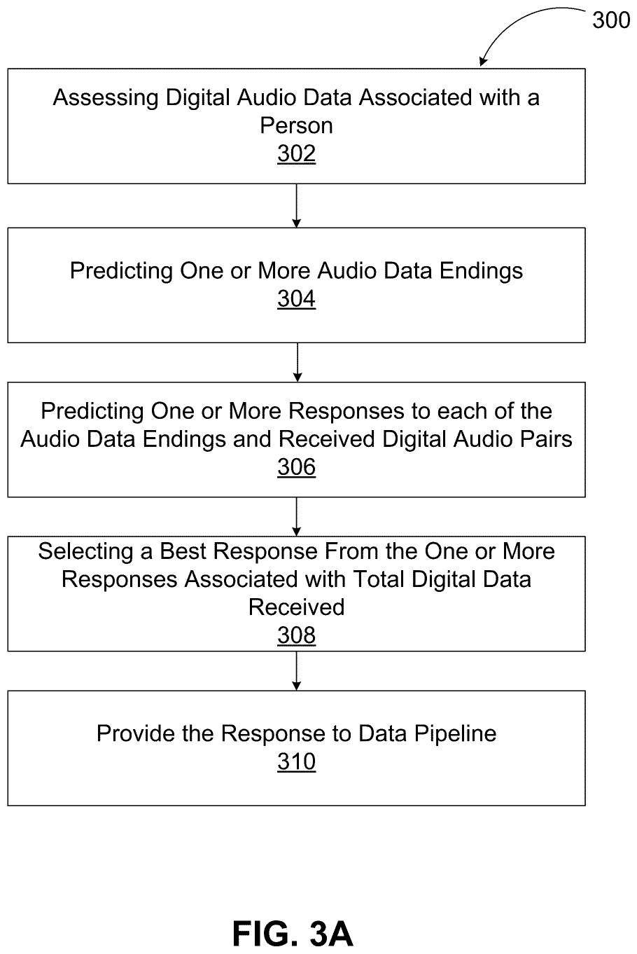

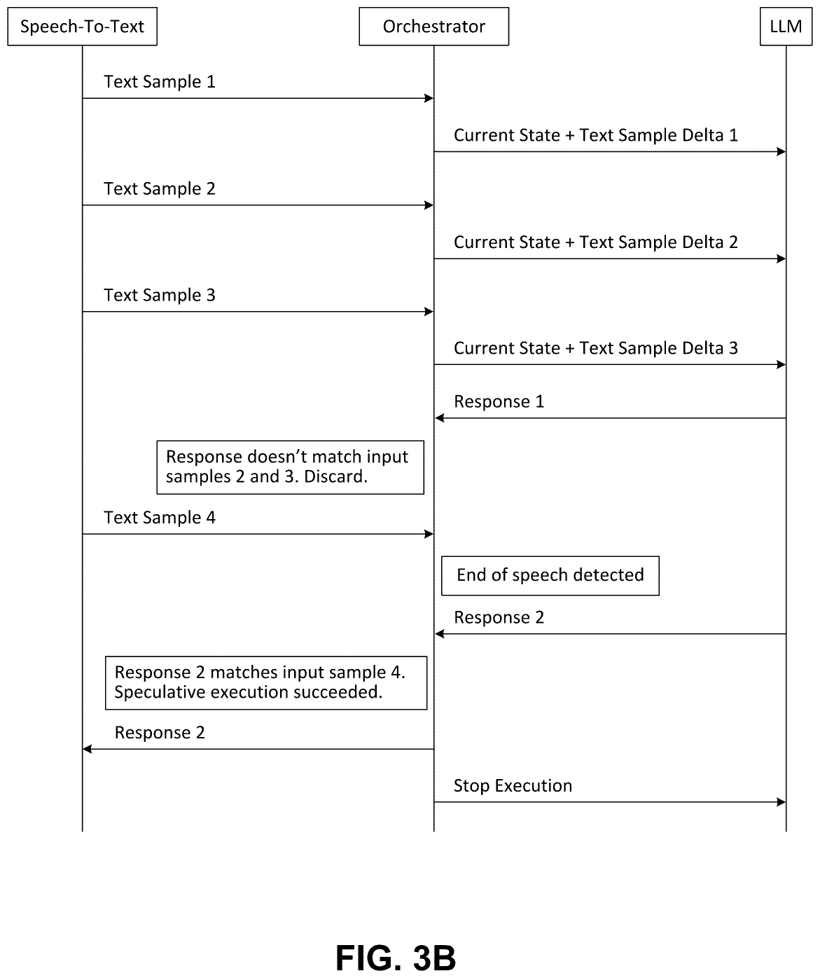

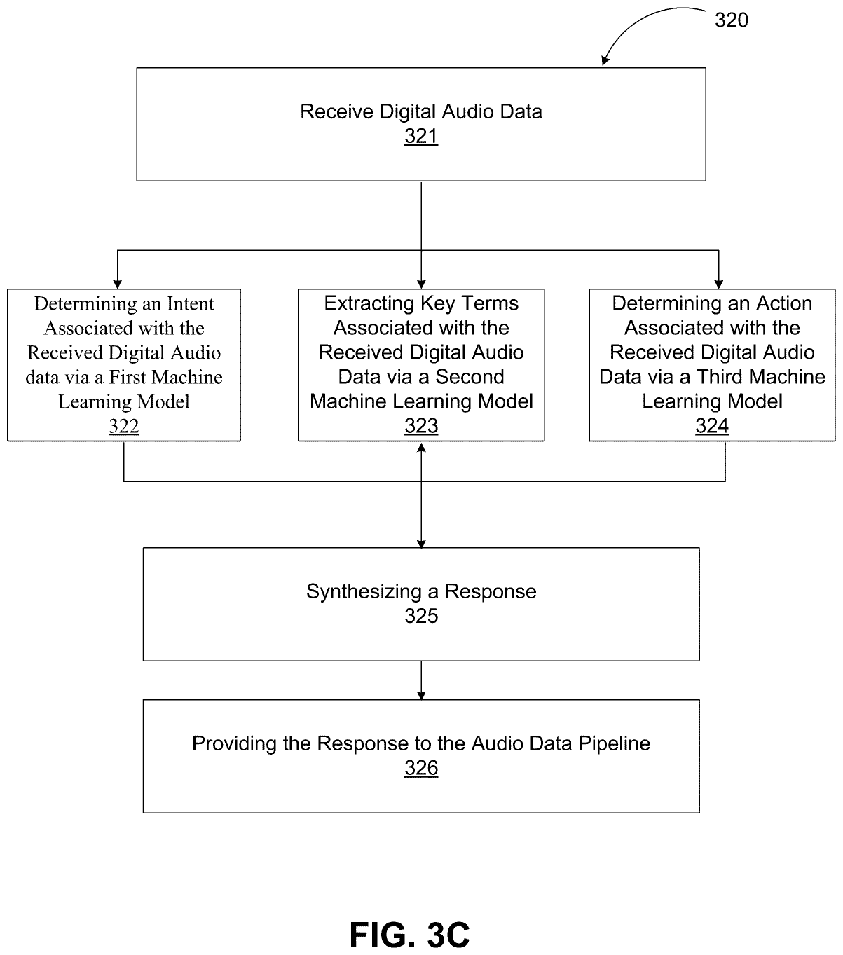

FIG. 3A illustrates an example method of a predictive machine learning process 300 associated with a data pipeline for VoIP, in accordance with an example of the present disclosure. In FIG. 3A, the process of FIG. 2 may be implemented prior to the method of predictive machine learning. The predictive machine learning process 300 may initiate with receiving one or more digital audio data from a speech-to-text process (e.g., speech-to-text 204 of FIG. 2). At block 302, the predictive machine learning process 300 may assess portions of digital audio data as they are received from a device (e.g., device 208), wherein the portions of digital audio data may be determined based on one or more factors such as but not limited to a particular number of words, a time associated with the audio signal, or the like. For example, a predictive machine learning process 300 may be configured to assess one or more portions of the digital audio data after three words are determined to be said by a user. For example, a predictive machine learning process 300 may be configured to assess one or more portions of digital audio data after two seconds of audio signal have been captured and received via the machine learning process 300. It is contemplated that any suitable metric may be used for the machine learning to begin assessing the digital audio data received. At block 304, the predictive machine learning model may begin to predict one or more of audio data endings, based on the one or more digital audio data received (i.e., the words, context, or the like), associated with what the user may continue to say until the reception of digital audio data ends (e.g., end of speech), wherein the end of speech may be determined by any suitable metric determined by the system (e.g., data pipeline 200 of FIG. 2). At block 306, the predictive machine learning model may determine a response for each of the predicted number of finished audio data determined at block 304, wherein the response may be based on the words, context, pitch, tone, or the like of the digital audio data received and the predicted finished audio data. At block 308, a total of the digital audio data may be received, wherein a selection of the number of responses determined at block 306 may be performed. The selection may compare each of the number of responses determined at block 306 to the total digital audio data. At block 310, The response that best fits the total digital audio data may continue through a data pipeline (e.g., data pipeline 200 of FIG. 2) to convert the response to a response analog audio signal for providing sound associated with the response to the user associated with the device (e.g., device 208). In some examples the number of responses that do not fit the total digital audio data may be discarded from the machine learning system. As disclosed herein, the number of responses and the continuation text may be determined based on an assessment of the context of the digital audio data, a historical database, or the user of machine learning operations (also referred as model herein), such as large language models. The historical database may comprise books, newspapers, articles, conversations, television shows, or the like, or any combination thereof.

FIG. 3B may provide an illustrative schematic of the method of FIG. 3A, viewing FIG. 3B from top to bottom and from left to right. A speech-to-text (e.g., speech-to-text 204) may send one or more samples of digital audio data (e.g., text sample 1, text sample 2, text sample 3, text sample 4) to a predictive machine learning process 300, wherein each of the text samples may be of varying length in time, words, or the like, or any combination thereof. As the text samples are captured, the machine learning process 300 may predict a continuation text (e.g., text sample delta 1, text sample delta 2, text sample delta 3) associated with the received text sample. As the predictive machine learning model may receive more text samples, the machine learning model may determine a response associated with each of the text samples and continuation texts. In some examples, as more text samples are received one or more responses may be disregarded if the associated response does not match a text sample received later. For example, text sample 1 and continuation text 1 (e.g., text sample delta 1) may provide a response that is similar to text sample 4, therefore the responses associated with text sample 2 and text sample 3 may be discarded. The end of speech may be detected, resulting in the remaining responses, i.e., response 1 and response 4 to be compared to the total received digital audio data. For example, response 4 may best fit the total audio data received therefore response 4 may be provided or continue to text-to-speech processes (e.g., text-to-speech 206) to provide sound associated with the response to the user. In some examples, when a response is determined to fit the total digital audio signal the predictive machine learning process 300 may stop execution until another or a new digital audio signal is received.

FIG. 3C illustrates an example method of a hierarchical ML process 320 associated with a data pipeline for VoIP, in accordance with an example of the present application. In FIG. 3C, some of the processes of FIG. 2 may be implemented prior to the method of adaptive filtering machine learning. The hierarchical ML process 320 may comprise two or more ML models, wherein one ML model would be considered a robust ML model where many datapoints may be assessed and the other ML models may be smaller, more specific machine learning models. The smaller specific ML models may be trained on one aspect associated with the digital audio data received. The smaller ML models may be trained on many features associated with the digital audio data such as, and not limited to, assessing user intent, entity names, performing actions, synthesize responses, or any combination thereof. The hierarchical ML process 300 begins with receiving one or more digital audio data from a speech-to-text process (e.g., speech-to-text 204 of FIG. 1). At block 321, the hierarchical machine learning process 320 may receive digital audio data via one or more machine learning models. At block 322 a first ML model may assess the user intent associated with the received digital audio data which comprises phonemes. The first ML model may be trained on books, newspapers, articles, conversations, television shows, or the like, or any combination thereof, geared toward determining only the intent of the received digital audio data.

At block 323, a second ML model may assess digital audio data to extract key words that may link to processes or specific resources. The second ML model may extract key words and limit potential responses based on the key words extracted. The second ML model may be trained on books, newspapers, articles, conversations, television shows, or the like, or any combination thereof, configured to only extract key terms associated with a resource. The resource may be any database, webpage, application or the like associated with an entity, company, third-party program, or the like.

At block 324, the third machine learning process may assess the digital audio data to determine an action associated with the received text. In some examples, the action may comprise fetching data from appropriate data sources to aid in providing a response to the user. The third ML model may be trained on books, newspapers, articles, conversations, television shows, or the like, or any combination thereof, configured only to perform actions based on the received digital audio data.

At block 325, a fourth machine learning model may synthesize a response based on the processes of block 322, block 323, or block 324. The response may be determined based on an assessment of the digital audio data, a historical database, or the user of machine learning operations (also referred as model herein), such as large language models. The historical database may comprise books, newspapers, articles, conversations, television shows, or the like, or any combination thereof. In an example, the fourth ML model may be a robust ML model that may receive data associated with the functions of the first ML model, second ML model, and the third ML model to determine a response based on an assessment of the outputs of the ML models (e.g., intent associated with the first ML model, key words associated with the second ML model, and actions associated with the third ML model).

At block 326, the robust ML model (e.g., the fourth machine learning model) may compare the outputs to determine a response to the digital audio data to provide a response to a data pipeline (e.g., data pipeline 200) to continue and provide sound to a user associated with the response. The first machine learning model, second machine learning model, and the third machine learning model may be machine leaning models that are trained on smaller historical databases than the robust machine learning system. It is contemplated that the method of a hierarchical machine learning process 320 may be performed in any number of steps that may happen concurrently, in a stepwise manner, or any other suitable sequence or fashion. It is further contemplated, that there may be any number of ML models in the method of an hierarchical machine learning process 320, wherein each of the ML models may divide up tasks associated with providing a response to a received digital audio data.

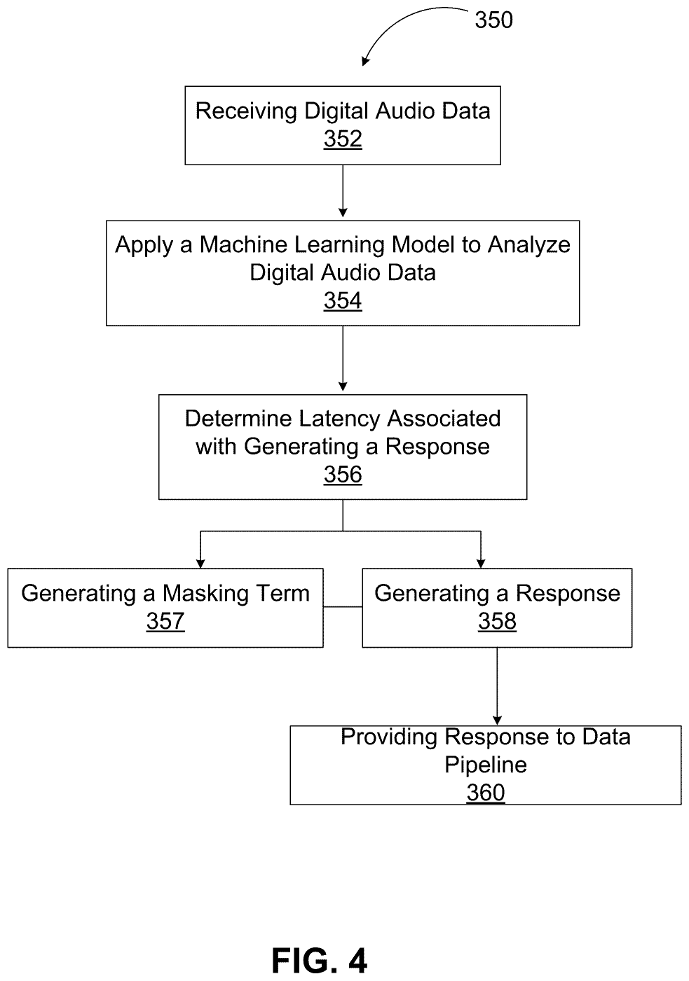

FIG. 4 illustrates an example latency masking process 350 associated with a data pipeline for VoIP, in accordance with an example of the present disclosure. At block 352, a machine learning model may receive digital audio data from an audio signal data pipeline (e.g., date pipeline 200 of FIG. 2). At block 354, the ML model may be applied to analyze the digital audio data received, wherein the ML model may determine context associated with the digital audio data.

At block 356, the ML model may determine a latency associated with generating a response based on the received digital audio data, wherein the latency may be a time associated with generating the response. The time may represent a gap in time above a threshold where the audio received from the user device and audio signals sent to the user device associated with the response via an AI bot associated with VoIP. It is contemplated that the threshold may be any increment of time suitable for the audio data pipeline (e.g., audio data pipeline 200), for example, the threshold may be 2 seconds of time between the received audio signal associated with a user device and the sent response audio signal associated with the VoIP process. When the latency does meet the threshold, the process may proceed to block 357.

At block 357, the machine learning model may send to the user device a masking phrase or term, wherein the masking phrase or term is configured to distract the user from the time needed to generate a response. The masking phrase or term may be any suitable phrase or term such as but not limited to, “let me think about that,” “hmmm,” “uhm,” “one moment please,” or the like, or any combination thereof. Concurrently to the processes of block 357, at block 358 the ML model may generate a response associated with the received digital audio data and the context determined at block 354. It is contemplated that block 356 and 358 may be one process or step in the latency masking process 350. In such examples when the machine learning process determines the latency associated with generating the response (e.g., block 358) reaches a threshold the latency masking process 350 may provide a masking term or phrase (e.g., block 357) to a device (e.g., user device). At block 360, the response audio data may continue to the audio data pipeline (e.g., data pipeline 200), where the response audio data may be converted to an analog audio signal to be provided to a user via a microphone associated with the user device.

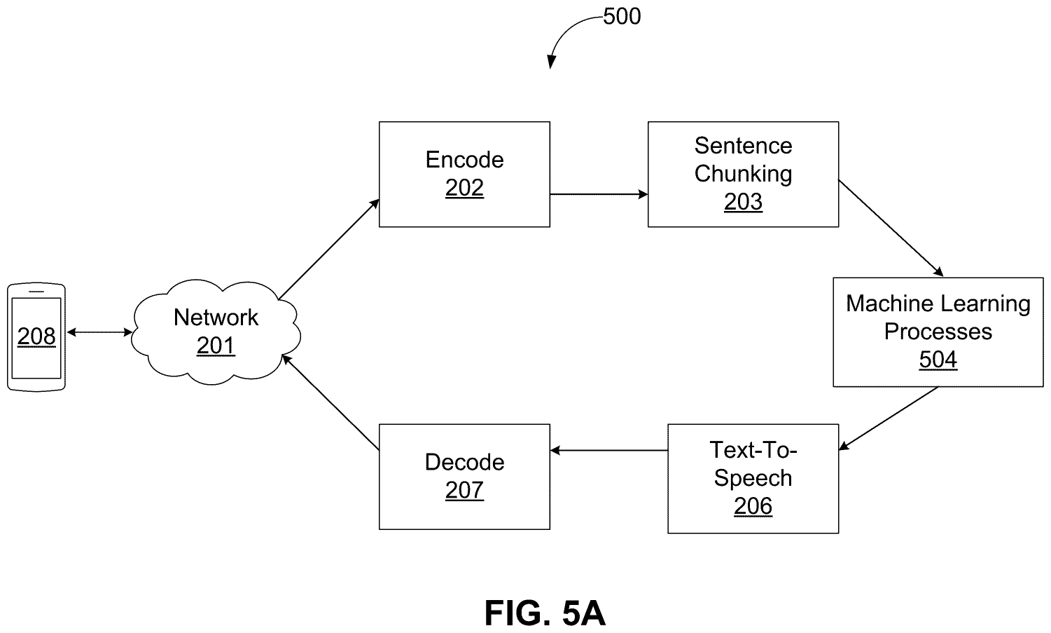

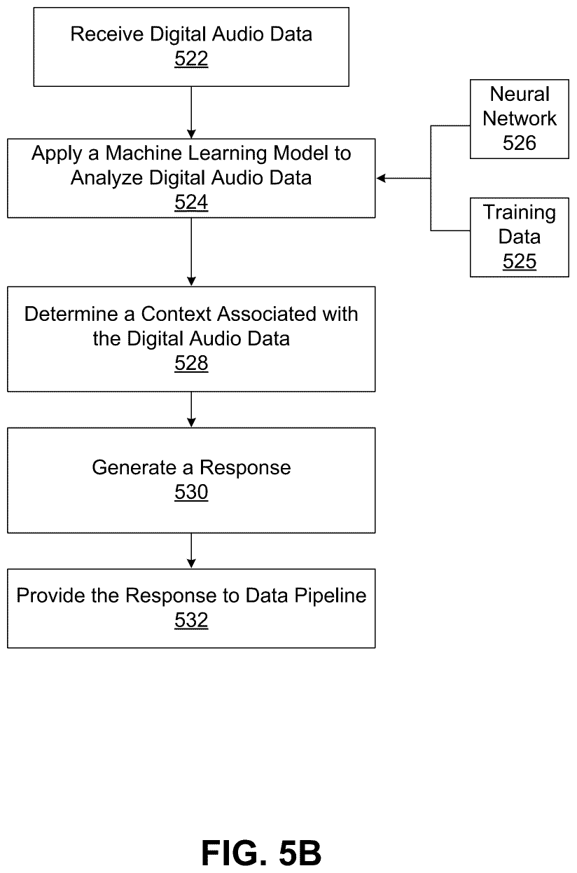

FIG. 5A illustrates an example data pipeline 500 associated with a voice over internet protocol (VoIP), that may utilize a phoneme adaptive machine learning model. The data pipeline 500 may comprise any of the devices and/or features of FIG. 2, such as network 201, encode 202, sentence chunking 203, text-to-speech 206, and decode 207. It is contemplated that network 201 may be configured to be in communication with a server where the following processes may occur. Such processes may include but not limiting to encoding 202, sentence chunking 203, machine learning (ML) model 504, text-to-speech 206, and/or decoding 207. Although FIG. 5A is illustrated in a specific manner with a specific user device, it is contemplated that any user device 208 connected to network 201 may be able to perform the processes of associated with VoIP. In some alternate examples, the some of the processes of data pipeline 500 may be performed on a user device 208.

In an example, device 208 may be associated with an individual (e.g., a user). In particular examples, device 208 may attempt to initiate a conversation or a call to an entity. In particular examples, one or more users may use one or more devices (e.g., device 208) to send data to, or receive data from data pipeline 500 to which may be located on a server, device (e.g., device 208) or the like. This disclosure contemplates any suitable device (e.g., device 208). A device 208 may enable a user to access network 201. In some examples, device 208 may enable a user(s) to communicate with a bot associated with an entity. In particular examples, device 208 may comprise a number of sensors (e.g., microphones) to capture data (e.g., audio signals) and information necessary to provide speech or WAV files associated with speech of a user to network 201, wherein network 201 may be communicatively linked to an entity. In particular examples, device 208 may be configured to send an audio signal associated with the voice of a user via network 201 and receive a content item (e.g., a generated audio signal, video, image, text, or any combination thereof) in response to the sent audio signal.

A user device (e.g., device 208) may receive an audio signal (e.g., data) via a MEMS microphone, the received audio signal may then be sent to network 201, wherein the network 201 may be associated to a server where the audio signal may be processed. In some examples, the device 208 may send audio signals continuously to network 201. At the server, the audio signal may undergo a series of processes to convert the audio data to text, to determine a response based on the text associated with the received audio signal, and to convert the response to an audio signal such that the response may be heard by a user associated with the device. The audio signal (e.g., audio data) may undergo encoding (e.g., encode 202), where the audio signal may be converted from analog audio signals to digital audio data. The received audio signal is an analog signal in the form of a waveform, whereas digital signals (e.g., digital audio data) may be in binary form. The audio signal received via the device 208 may undergo encoding 202 such that the audio signal may be interpreted by a computer, a processor, a machine learning model (e.g., machine learning model 504), or the like. At encode 202 the analog audio signal may be converted to digital audio data, wherein the analog audio signal may be converted to any number of digital data formats such as but not limited to MP3, WAV, OGG, or the like.

At the sentence chunking step 203, the now digital audio data may be broken down into a number of segments or sentences. At the machine learning model 504, the segmented digital audio data may be assessed by a machine learning model. The machine learning model 504 may comprise one or more filters (i.e., neural networks) configured to match corresponding phonemes associated with segments of digital audio data, wherein each of the filters may be configured to a particular or specific phoneme. The machine learning model 504 may further analyze a context associated with the digital audio data via establishing a relationship between the phonemes and the encoded audio signal. The context may be used by the machine learning model 504 to determine a response text.

The machine learning model 504 may generate a response text. The response text may then undergo text-to-speech 206, where it (e.g., a response digital signal) may be converted to a number of response phonemes associated with the response text. Each of the number of response phonemes may comprise a specific duration and latent features of the response digital signal. The number of phonemes of the response digital signal may then be associated with an artificial voice (e.g., an AI bot voice). As a result, the response digital data may be decoded, via decode 207, where the latent features of the number of phonemes may be processed and an energy, duration, and pitch may be determined. In some examples, the decoder may convert the response digital data to acoustic features which are then converted to speech waveforms (e.g., a response analog audio signal) associated with the AI bot voice. The response analog audio signal may be sent to a loudspeaker (e.g., speaker) of device 208 to allow the user to hear the response determined via the machine learning processes 504.

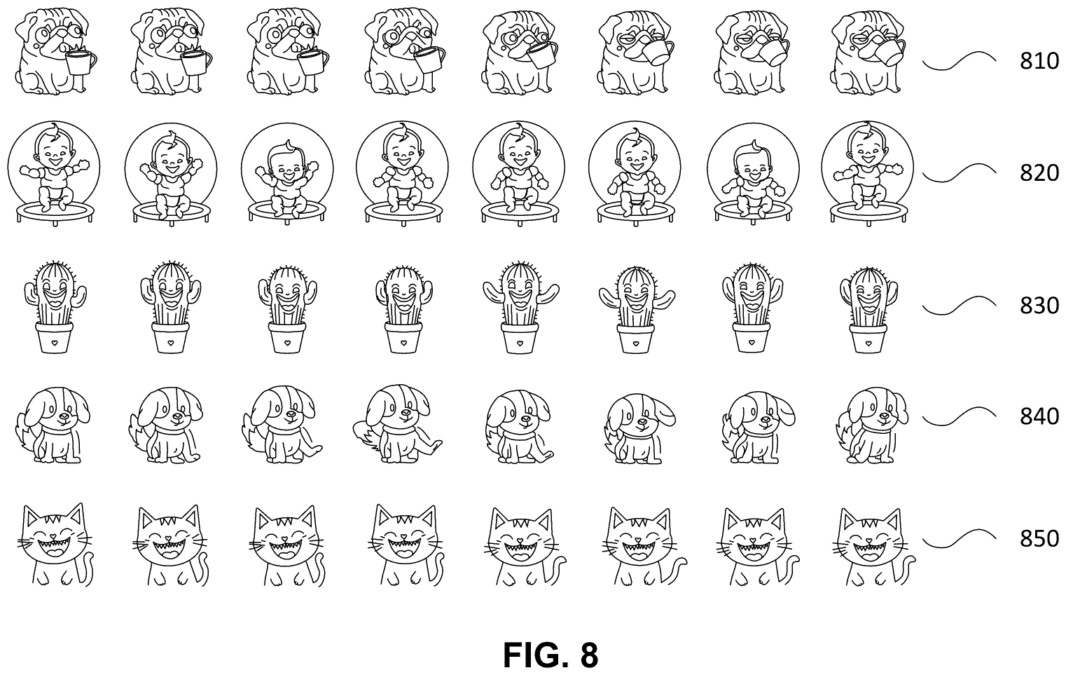

According to a further embodiment as depicted in FIG. 5B, an example method 510 of a phoneme adaptive machine learning model 504 associated with a data pipeline (e.g., data pipeline 510) for VoIP is described. At block 522 of FIG. 5B, the machine learning model 504 may receive digital audio data associated with speech (e.g., audio signal). At block 524, a machine learning model (e.g., machine learning model 504) may be applied to analyze the digital audio data 522. In some examples, a device (e.g., HMD 100 of FIG. 7 and FIG. 8) may execute the machine learning model (e.g., associated with block 524). One or more machine learning models may analyze the digital audio data to determine context of the conversation and a response to the received digital audio data. In various examples, the machine learning model may utilize training data 525 to develop and predict associations between phonemes, digital audio data, context of the digital audio data, or the like. The training data 525 may be historical data or associated with previous digital audio data received. In many instances, historical data may comprise but not limiting to books, movies, news articles, magazines, television shows, previous conversations of other users or the like. One or more neural networks 526 may assist in utilizing the training data or assisting with the machine learning techniques to analyze the phonemes associated with the received digital audio data. In an example, each of the neural networks may be trained on a particular phoneme.

At block 528, the machine learning model may determine a context associated with the digital audio data. At block 530, the machine learning model may generate a response based on the association between the received digital audio data 522, context determined via block 528, the phonemes associated with received digital audio data via neural network 526, and historical data, the generated response may utilize data directly from the machine learning model. At block 532, the response may continue through data pipeline 500, where the binary text associated with the response may be converted to a response audio signal to be provided to a user via a device (e.g., device 208).

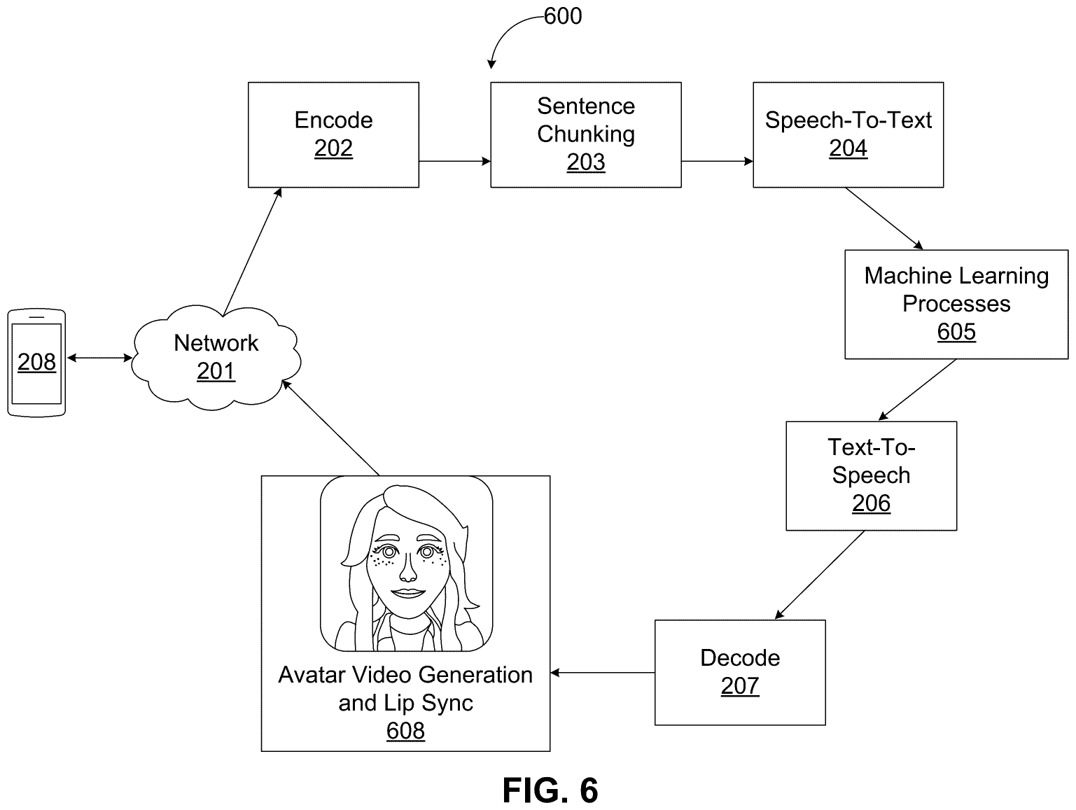

FIG. 6 illustrates an example use case of a generative artificial intelligence audio pipeline 600, in accordance with an example of the present disclosure. It is contemplated that the machine learning models of FIG. 3A, FIG. 3C, FIG. 4, and FIG. 5B may be configured to determine facial expressions, lip movements, and the like associated with the response, via an artificial intelligent avatar, bot or video. For example, a user may converse with an artificially intelligent bot via video call, within an AR system, on a computer, mobile device, or the like. In this example, A user device associated with the user may receive an audio signal (e.g., data) via a MEMS microphone, the received audio signal may then be sent to network 201, wherein the network 201 may be associated to a server, which is associated with a network device (e.g., network device 160 of FIG. 1B), where the audio signal may be processed. The network device may be associated with a company, entity, or the like, configured to provide a service to a user. A series of processes may be performed on the received audio data (e.g., analog audio data). The processes may convert the analog audio signal to digital audio data in a text or binary format (e.g., via encode 202), break the digital audio data into chunks (e.g., via sentence chunking 203), matching a corresponding phoneme to the chunked digital audio data (e.g., via speech-to-text 204). The digital audio data may then undergo any of the machine learning processes 605 described herein (e.g., FIG. 3A, FIG. 3C, FIG. 4, and FIG. 5B) to determine a response associated with the received digital audio data. The machine learning models (e.g., FIG. 3A, FIG. 3C, FIG. 4, and FIG. 5B), in this example, may further contain processes to determine a motion, facial expression, or lip movement associated with the response, such as for example but not limited to a smile, an excited facial expression, or any other suitable facial expression. The response and the facial expression associated with the response, may then be sent to a text-to-speech process (e.g., text-to-speech 206), where the response (e.g., a response digital data) may be converted to a number of response phonemes associated with the response text and the expression, motions, or the like determined via the machine learning processes 605. The digital audio data may then be decoded (e.g., via decode 207), where the latent features of the number of phonemes may be processed and an energy, duration, and pitch may be determined that may be associated with the response and expressions determined via the machine learning processes. In some examples, the decoder may convert the response digital data to acoustic features which are then converted to speech waveforms (e.g., a response analog audio signal) associated with the AI bot voice. In some examples, the expressions determined may be shown on a face associated with the AI bot, avatar, or video. The response and view of AI bot or avatar 608 may be provided to the user via a loudspeaker (e.g., speaker) of a user device (e.g., device 208) and a graphical user interface associated with the user device (e.g., device 208). The avatar or AI bot may be seen by the user performing the expression, movement, or lip syncing associated with the response and the determined actions in machine learning processes 605.

According to yet even another embodiment, FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. As shown in FIG. 7, process 700 may include a step of obtaining digital audio data associated with an audio signal from a user equipment of a user (block 702). As shown in FIG. 7, process 700 may include a step of determining, via a trained machine learning (ML) model including one or more neural networks, an indication associated with the digital audio data, wherein the indication is selected from any one or more of a prediction of an ending of one or more portions of the digital audio data, an intention of the digital audio data, a key term of the digital audio data, an action to take in view of the digital audio data, or context associated with the digital audio data (block 704). As shown in FIG. 7, process 700 may include another step of generating a response based upon the determined indication associated with the digital audio data (block 706). As shown in FIG. 7, process 700 may include a further step of transmitting the response to the user equipment of the user (block 708).

### Latent Diffusion Video Modeling for Animated Sticker Generation

FIG. 8 illustrates an example of animated stickers generated in accordance with aspects discussed herein. Animated motions may display a high degree of quality, consistency, expressiveness and relevancy to a subject.

For example, animated sticker set 810 illustrates a playful, whimsical sticker showing a pug covering its eyes in embarrassment while trying to drink its coffee. Animated sticker set 820 illustrates a person jumping in the middle of a trampoline. Animated sticker set 830 illustrates a cactus laughing aloud. Animated sticker set 840 illustrates a dog playfully shaking its tail. Animated sticker set 840 illustrates a cat laughing aloud.

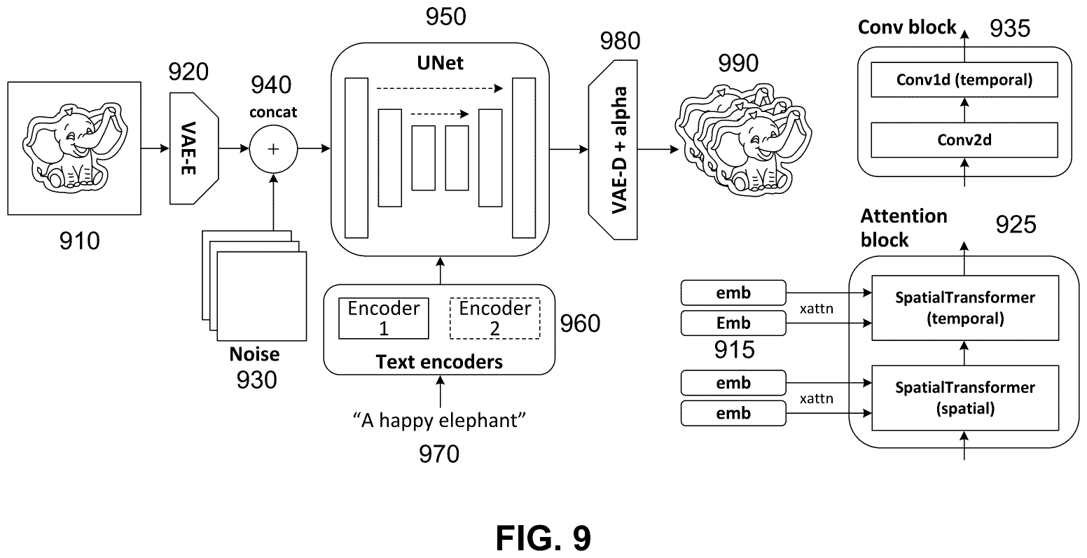

FIG. 9 illustrates an overview architecture 900 employed to generate the animated stickers illustrated in FIG. 8. The architecture 900 utilizes a latent diffusion model (LDM) with additional temporal layers and uses a IP2P-style conditioning. The model may receive an input, e.g., image 910, and utilizes a variational autoencoder (VAE 220), UNet 950, and one or more text encoders 960 to process a text string 970. The input (e.g., image 910) is passed to VAE 920, concatenated (concat 940) with noise 930, passed to UNet 950, then a second autoencoder 980 (e.g., VAE-D+alpha), to generate an output 990 (e.g., an animated sticker).

The UNet 950 uses the layers and weights, with 1D convolutions (e.g., Conv. Block 935) across the time axis inserted after each 2D convolutional layer in ResNet blocks, and temporal attention layers inserted after each spatial attention block. Temporal layers are identity-initialized, so that a newly initialized model with only T2I weights can exactly reproduce text-to-image generation. FIG. 9 illustrates using two conditioning signals, although more or less signals may be used in accordance with aspects discussed herein.

Image conditioning may be applied by cloning the image across the time dimension and appended along the channel axis to the noise. Text conditioning may also be applied by encoding a prompt (e.g., blocks 915) and fed into cross-attention layers 925.

In an example, two conditioning signals are used, which enables classifier-free guidance (CFG) by dropping text and image conditioning each separately between 5 and 10% of the time and together between 5 and 10% of the time during training, and use the IP2P CFG formulation at inference,

$${\tilde{ϵ}}_{θ} ( {z}_{t} , {c}_{I} , {c}_{T} ) = {ϵ}_{θ} ( {z}_{t} , ∅ , ∅ ) \qquad ( 1 )$$

$$+ {σ}_{I} ( {ϵ}_{θ} ( {z}_{t} , {c}_{I} , ∅ ) ) - {ϵ}_{θ} ( {z}_{t} , ∅ , ∅ ) ) \qquad ( 2 )$$

$$+ {σ}_{T} ( {ϵ}_{θ} ( {z}_{t} , {c}_{I} , {c}_{T} ) ) - {ϵ}_{θ} ( {z}_{t} , {c}_{I} , ∅ ) ) \qquad ( 3 )$$

where zₜ is the noisy latent, c_{I} and c_{T} are the image and text conditionings, respectively, and σ_{I} and σ_{T} are the image and text classifier-free guidance scales. In an example, σ_{I} may be in the range 7.5 to 9 and σ_{T} in the range 1.5 to 3. As an implementation detail, since the present example uses a combination of spatial and temporal layers, the tensors may be “rolled” (b c t h w→bt c h w) and “unrolled” (bt c h w→b c t h w) as necessary for passing into spatial and temporal layers, respectively.

In sum, the architecture of FIG. 9 employs a spatiotemporal latent diffusion model (LDM) with the addition of temporal layers to the transformer and convolutional blocks. The UNet consists of convolutional stages and attention stages, where the attention stages perform both self and cross-attention to text models. Temporal layers may be added after convolution and spatial transformers, with identity-initialization so that a newly initialized model can load T2I weights and reproduce the T2I model. The temporal dimension may be “rolled” and “unrolled” into the batch dimension as necessary for passing into spatial and temporal layers, respectively.

### Pretraining

The following section discusses various aspects of training video generation systems and method. Natural videos may be used for pretraining models, and in an example, over 35 million natural videos available online were used for pretraining video models. Data used for in-domain finetuning included two large (15-60 k) animation datasets curated from social media, as well as high quality, professionally-animated sticker sets.

Keyword Based Sourcing+Manual Filtering. To collect a large volume of animation style videos, e.g., from social media platform(s), keyword matching may be used to source videos, e.g., 15,000 videos. Human annotation may be applied to down select videos which were on-style and had high motion quality, resulting in a dataset (e.g., 4,000) human-filtered videos.

Artist set. Collections of images, videos, stickers, and the like may also be analyzed. In an example using a set of artist-animated sticker packs, the set may be filtered manually or automatically to remove stickers with text overlaid or depicting certain features/elements not of interest. In examples, over 1,800 animated stickers were curated. High quality in-domain videos ideally do not include low quality motion, such as very fast “jittering” or videos which alternate between only two frames. Other types of stickers may be filtered out manually.

K-Nearest Neighbor (KNN) To further expand pretraining data, video embeddings may be used to perform KNN searches of short videos online, e.g., social media, using human-curated videos and/or artist sets as seeds. A video understanding model may be used, and trained, for example, using temporal attention and considered different modalities like visual frames, audio, optical character recognition (OCR) and other signals to produce a multimodal video embedding. The model may be experimentally validated and significantly outperform other simpler video embeddings extracted, for example, using only the thumbnail of the video or just visual frames.

An artist set may have human-written captions which provide detailed descriptions of both motion and content. In an example, original captions for KNN and keyword-based sources may be noisy and/or do not necessarily describe the video. To improve these captions, a video captioning model and an entity extraction model may be applied. In an example, a video captioning model may be trained using the divided spatial-temporal self-attention mechanism discussed herein. A two-stage training strategy may be adopted to train the video captioning model. For example, a pre-training stage using the online dataset, and a finetune stage using the animated videos and the aforementioned artist dataset. To extract the named entities from each video's original post, an entity linking system built on online knowledge base(s) may be leveraged. By concatenating the outputs from both models, richer descriptions may be generated that capture both motion and visual objects in detail. Such datasets may represent varying levels of trade-off between quantity and quality and allow training of the ensemble-of-teacher models discussed herein.

After initializing with text-to-image weights, the 12V architecture may be pretrained using a large video dataset (e.g., 35 million videos). The highest quality general-purpose 12V models were found to be ones trained using a multi-stage process, where at each stage, one or more of the following hyperparameters are changed, in addition to tuning normal training parameters such as learning rate and number of training iterations: (i) whether spatial weights are frozen or unfrozen; (ii) spatial resolution, either 256p or 512p; and (iii) frame sample rate, e.g., 4 fps, 8 fps, or dynamic, i.e., the quantity which the UNet predicts, either the noise E or the phase velocity v. Additionally, when using v prediction, the noise schedule for zero terminal signal to noise ratio (SNR) is rescaled). An example of a pretraining recipe includes (i) 256p, freeze spatial, 8 fps, E-prediction; (ii) 512p, freeze spatial, 8 fps, E-prediction, and (iii) 512p, unfreeze spatial, 4 fps, v-prediction.

Using different training recipes allows tradeoffs between motion size and consistency. Empirically, it was found that training with E-prediction in early stages increases motion size and starting from a smaller spatial resolution increases motion quality of the final model. Training was performed with v-prediction and zero terminal SNR in the final stage, as videos generated with v-prediction have dramatically better color saturation compared to c.

In various examples, models were trained employing GPUs with batch size between 128 and 512, learning rate between 2.5e-5 and 1e-4, and number of iterations between a few thousand and a 150 thousand, depending on whether the models were finetuning or pretraining. Videos were resized and center-cropped during training, and 1-second (sample rate of 8 fps) or 2-second (sample rate of 4 fps) clips and uniformly sampled 8 frames from the clips were randomly selected as training examples.

It should be appreciated that the model may output any of a plurality of frames (e.g., more or less than 8 frames). Increasing the number of frames while maintaining inference time provides significant improvements over existing video generation models. In addition, modifying model outputs to ensure smooth looping would improve user experience, since stickers are automatically looped for users, and large jumps between the first and last frame cause an unpleasant effect. The overall quality of primary and secondary motion may also be improved by expanding and further filtering datasets, tweaking model architecture, and further reducing quality loss in inference optimizations.

Motion bucketing. When sampling training clips from videos, all videos from a dataset may be sampled at the same framerate, with uniform spacing between frames in the clip. For example, when sampling a 24 FPS video at 4 frames per second, every sixth frame is sampled, with the general spacing between frames given by

$$min ( round ( \frac{video fps}{desired fps} ) , ⌊ \frac{video frames}{desired frames} ⌋ ) \qquad ( 4 )$$

However, real-world video datasets will typically contain videos with artificial speed-ups and slow-downs. Additionally, the true level of motion varies widely between videos, and even between different parts of the same video. For applications like sticker animation, a consistent level of motion (neither too much or too little) is key, so a method was introduced to normalize sampling frame rate against actual motion size.

In various examples, a motion score for a video may be computed, and the scores placed into FPS “buckets” via manual inspection of videos within each bucket. In a first example, a measurement of the temporal difference between adjacent frames was used for the score. In another example, the score averaged the norm of the motion vectors from a H.264/MPEG-4 AVC standard designed for inter-prediction of macroblock offsets to reference frames, over all frames. FPS bucketing results in a mapping between scores and sampling FPS, used to dynamically sample videos at train-time. This method is particularly applicable to longer videos, where it is possible to sample at different framerates. The HITL data, for example, has only eight frames and does not permit motion bucketing. Practically, it was found that in-domain fine-tuning with motion bucketing improves motion consistency and reduces variance in motion size.

First vs. middle frame conditioning. When choosing which frame to use as conditioning during training, the most obvious choice is the first frame. That is, when sampling clips from videos at train-time, use the first frame of the sampled clip as image conditioning. However, at inference-time, the image generated from a prompt with an action (e.g., two people high-fiving) will typically render an image depicting the middle or end of the action. Second, generated frames further in time from the conditioning frame have been empirically found to be more likely to be inconsistent or introduce artifacts. For these reasons, a middle frame (e.g., a fourth frame out of eight) was used for image conditioning and found to improve the motion consistency.

Other possible choices for frame conditioning are last frame, and randomly selecting a frame. When experimenting with these, it was found that using the last frame gave similar results as using the first frame, and using a random frame gave noticeably worse results. A visual comparison between first-frame and middle-frame model generations is discussed in the embodiments to follow.

### Human-In-the Loop (HITL)

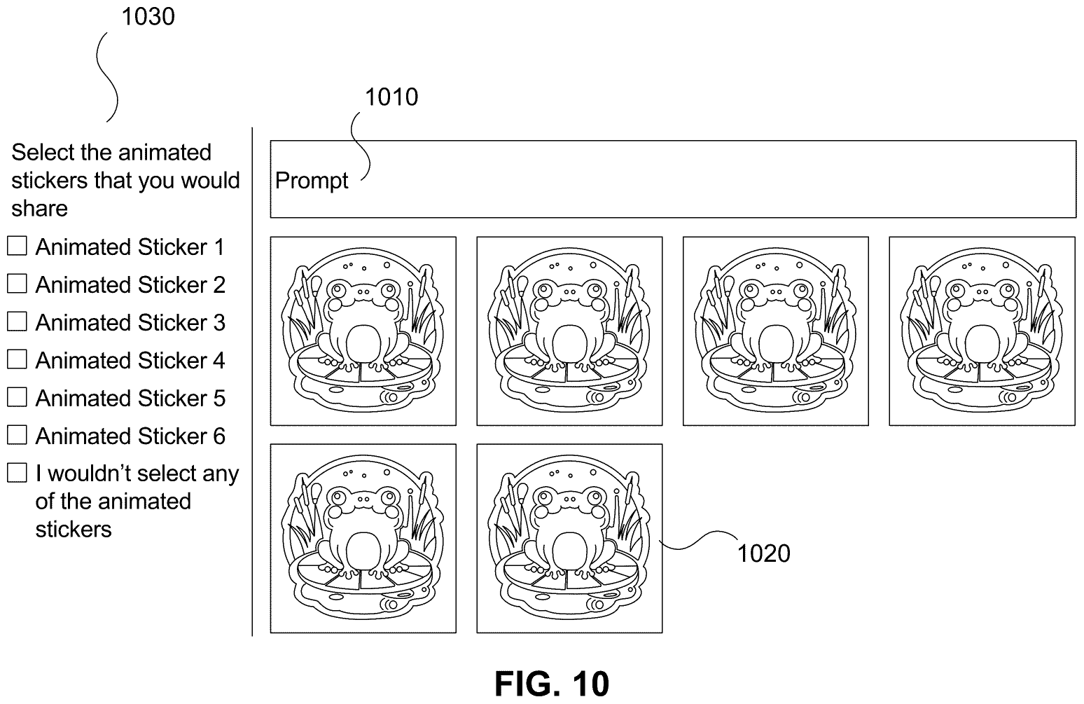

FIG. 10 illustrates an example annotation interface, which is usable for model training and incorporates human-in-the-loop (HITL) aspects as discussed herein. In section 1030, selections may be provided to enable an annotator to select which videos 1020 appear acceptable, in connection with the provided prompt 1010. Any number of the available videos may be selected as “acceptable,” or “not acceptable (e.g., “I wouldn't share any of these image”). In a section of the screen, the annotators can see the prompt 1010, and auto-loop animated sticker videos. In some examples, between 4 and 8 choices are available depending on the task.

Data for human-in-the-loop (HITL) may be created by curating a set of prompts (e.g., 15000 prompts), and then sending the prompts into the static stickers model to generate two images per prompt. The prompts came from two main sources: a previous static sticker HITL prompt set, and generations using LLAMA. The prompts generated from LLAMA were curated to describe dynamic motions in order to optimize for large motion in the animated stickers.

The prompt-image pairs were then used to generate videos using a number of teacher models, discussed herein. Generated videos were sent to human annotators for filtering that fulfilled the shareability guidelines. The shareability guidelines is defined by three main criteria:

Motion Quality. Motion quality is defined as the amount of motion, smoothness of the motion, and if the motion is natural and expressive. A shareable animated sticker will have large motions that is smooth and natural.

Relevance. Relevance looks to see if the purpose of the animated sticker is clear with no room for misinterpretation. The movement in the animated sticker is expected to be related the subject and prompt.

Consistency. A shareable animated sticker should not distort or morph in any way.

A first round of filtering may be performed, and followed by a second round of filtering, to ensure the highest quality data. Each round of filtering included jobs that showed six different animated stickers. The annotators were instructed to select all of the animated stickers that fulfilled the shareability criteria. FIG. 10 shows an example of the interface that the annotators saw. The final selection of animated stickers was used to train the student models.

An analysis on the prompt breakdown on the base HITL set and the accepted HITL set is shown in Table 1. The prompts were split into three different buckets: (i) Action prompts, which focused on various actions, ranging from simple actions, such as “a person waving”, to dynamic actions, such as “a speeding car navigating a winding road”; (ii) Emotion prompts, which, to capture a wide variety of emotions, ranged from simple prompts, such as “a girl crying”, to complex prompts, such as “a dejected-looking puppy with its ears drooping and its tail between its legs”; and (iii) Open-ended prompts, which describe any prompts that do not fall into the emotion and action prompt buckets, such as prompts about scenery and one word prompts.

TABLE 1

| Category | Base HITL Set | Accepted HITL Set |
|---|---|---|
| Total Prompts | 15000 | 1520 |
| Action Prompts | 7236 | 821 |
| Emotion Prompts | 4252 | 472 |
| Open-ended Prompts | 3512 | 225 |

### HITL Set

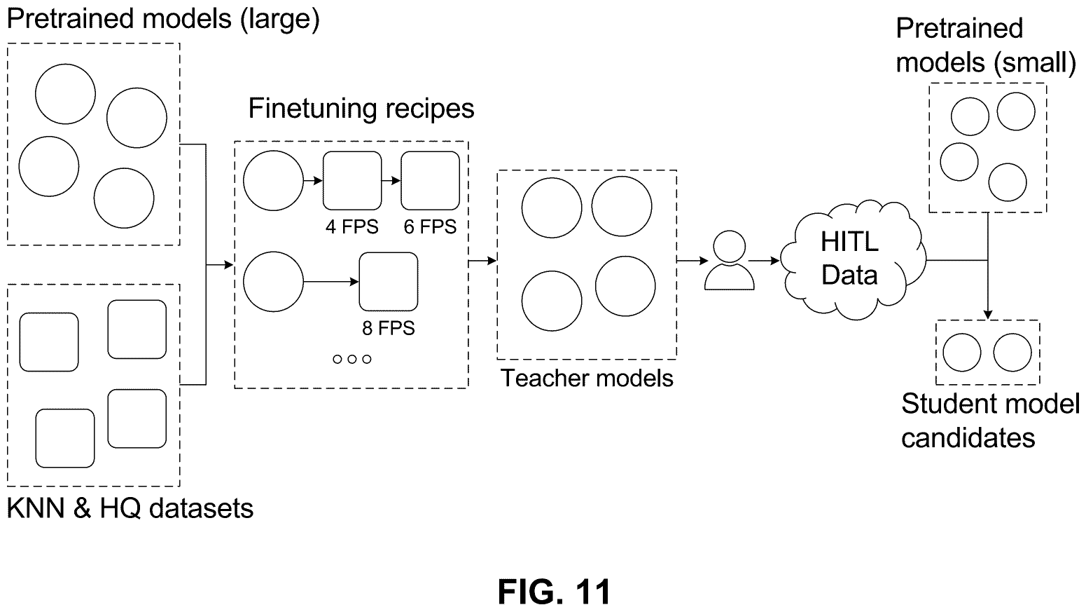

FIG. 11 illustrates and ensemble-of-teachers finetuning, where a number of pretrained, large general-purpose video models may be finetuned using finetuning data and different recipes, which vary by data order and sampling framerate. This results in a set of “teacher” models, which are used to generate videos with the HITL prompt set. After human filtering, high-quality HITL data is used to finetune a set of small, efficient pretrained models and down selected into student model candidates.

Static stickers used in a human-in-the-loop (HITL) finetuning strategy may improve text faithfulness and style adherence. Since the style and text faithfulness for the content of the video is overwhelmingly determined by the image used as conditioning, HITL approach may be tailored specifically to improve motion quality and diversity. An HITL finetuning strategy therefore may have three objectives:
(1) Distill high quality motion from large models into smaller models, for efficient inference;
(2) Bridge the domain gap between the pretrained models, which were trained on general videos, and static stickers;
(3) Maximize the diversity, relevance, and interestingness of animated sticker motion

The ensemble-of-teachers HITL finetuning, differs from the HITL used for static stickers in two ways: (1) Multiple expert-selected models are used to generate the HITL data for human annotation; and (2) The models which generate the HITL data have different architectures (typically larger) than the models which train on it.

Several pretrained foundational models were selected for different levels of motion size vs. consistency, and finetuned using finetuning recipes. This produces a number of teacher models which are then down selected by human experts according to two factors:

High peak quality. Since aspects human-annotate a large number of generations for each model, models may be judged on their best generated videos, rather than the average. This allows filtering for very high quality, interesting animations from each teacher model even if the majority of the videos produced by that model are poor.

Diversity of motion. Teacher models ideally have minimal overlap between each other in terms of motion speed, novelty, and quality in different actions. For example, one teacher model may be great at producing running and walking motions but poor at others. Notably, examples may train on the same data while sampling at different framerates, so that models trained at different framerates have different distributions of motion speed.

These teacher models may be used to generate videos from an HITL prompt and image set which is filtered by human annotators, engineers, and creatives (covered in the previous section). The down-selected high quality HITL set is then used to train a number of pretrained student models, some of which may be architecturally different than the teacher models. Finetuning on data which is more aligned with the output distribution makes the model generate more stable, consistent, and higher quality motion. Also, teacher models trained on noisier data (e.g., the KNN data) often produce large but low-quality and inconsistent motion. However, this is tolerable for the purposes of HITL, since “lucky” instances may be filtered where the motion is both large and consistent.

### Model Optimizations

Since the animated stickers model is intended to be used in production, it needs to perform inference quickly in addition to producing high quality motion. Strategies may be applied to trade-off between inference time and quality: training-free optimizations, reducing the number of UNet weights, and model distillation. These are detailed below.

In training-free optimizations, general optimizations applicable to any latent diffusion model at inference may be employed, independent of architecture or distillation.

Halving the floating point precision is another technique usable to convert a model, for example, from Float32 to Float16. This approach may speed up the inference time for two reasons. First, the memory footprint of the model is halved. Second, 16 floating point operations can be executed faster. In an example, BFloat16 (a float16 variant with a smaller mantissa) may be used for training and inference.

Torchscripting and freezing is yet another technique in accordance with aspects discussed herein. TorchScript is a serialized format for easy deployment of PyTorch models. Converting a model from pure PyTorch to TorchScript involves automatic optimizations that can increase inference speed, such as fusing multiple operations, constant folding, and techniques to reduce the complexity of the computational graph. Additionally, freezing (referring to jit.freeze, not weight freezing) allows further automatic speed optimizations in Torchscript, by converting dynamic parts of the graph into constants to remove unnecessary operations. Importantly, freezing with the flag may preserve the numerics and prevent quality degradation.

In optimized temporal attention expansion, Temporal attention layers (attending between the time axis and text conditioning) require the context tensors to be replicated to match the number of frames (the time dimension). In a naive implementation, this may be done before passing to cross-attention layers. An optimized version may take advantage of the fact that the repeated tensors are identical and expands after passing through the cross-attention's linear projection layers, reducing compute and memory.

In another example, a Diffusion Probabilistic Model (DPM) Solver may be applied. A DPM-solver may provide significant advantages than other inference models that typically require more sampling steps for good quality generation. Examples may utilize a DPM-solver and a linear-in-logSNR time schedule at inference to reduce the number of sampling steps.

Adaptive guidance provides a novel technique that reduces the number of network evaluations from three to two to one for a subset of the sampling steps. In effect, less forward passes through the network are executed and memory usage is reduced. These two effects result in faster inference speed without any quality degradation. In practice, aspects may perform full guidance, for example, for the first eight (out of 15) sampling steps, and no guidance for the remaining seven.

With these optimizations, aspects of the present disclosure may be able to reduce inference time by an order of magnitude when compared to a fully unoptimized model (e.g., DDIM 50 steps, full precision, full guidance) with minimal change in quality.

To improve model efficiency, aspects of the subject technology may reduce the number of weights. These weights may include, but are not limited to (i) Number of UNet channels; (ii) UNet spatial and temporal transformer depth; (iii) Number of UNet resnet blocks per UNet block; and (iv) Whether to include the T5 text encoder or only use CLIP.

Notably, aspects need not reduce the number of latent channels (e.g., 8 channels for experiments discussed herein), and it was empirically found that having at least 8 channels is important to reducing visual artifacts and morphing. As an example, at 512p, the foundational UNet has 4.3 B weights and uses 23.5 teraFLOPs, whereas a more efficient UNet (“sm”) has 1.2 B weights and uses 5.6 teraFLOPs.

For students models, the potential models were to four UNet architectures: (i) “Ig”, 4.3 B UNet weights; (ii) “Ig-e” (Ig-efficient), with fewer res blocks, and no T5 encoder, 3.5 B UNet weights; (iii) “med”, 2.4 B UNet weights; and (iv) “sm”, 1.2 B UNet weights.

These models may be pretrained using similar recipes as used for the teacher models discussed above, with the notable difference being student models are all trained up to a maximum of 256p, since that is the required output size.

To speed up the inference further, distillation techniques may be implemented to reduce a number of forward passes through the UNet without affecting the parameter count. Such techniques may include guidance distillation and step (or progressive) distillation.

In Guidance Distillation, diffusion models use classifier-free guidance for conditional image generation, which requires a conditional and unconditional forward pass per solver step. Guidance Distillation reduces these two forward passes into one. However, in the case of the animated stickers model, classifier-free guidance requires three forward passes per step: a full conditional (text and image), unconditional, and an image-conditional step. Applying guidance distillation to reduce three forward passes into one has not yet been described in the literature, but has been found to work well in practice, reducing inference time threefold.

In Step-Distillation, a teacher and student are initialized with the same weights, and the student is trained to match multiple teacher steps in a single step.

In Guidance+Step Distillation, guidance and step distillation are combined by training a student to imitate classifier-free-guidance and multiple steps at the same time with just one forward pass through the UNet. In some examples, a four-to-one ratio of teacher to student steps may work best, i.e., distilling 32 teacher steps into 8 student steps during training. In various examples, a model may only require eight solver steps, with one forward pass through the UNet per step.

For each of the four efficient UNet architectures (sm, med, Ig, Ig-e), training-free optimization, guidance distillation, and Guidance+Step distillation were evaluated. The benchmark times on A100 and H100 for batch size 1 are shown in Table 2. The final down selected model is bolded.

TABLE 2

| Model | A100 time (ms) | H100 time (ms) |
|---|---|---|
| sm-guidance-step | 503 | 300 |
| sm-guidance | 597 | 363 |
| med-guidance-step | 753 | 449 |
| lg-e-guidance-step | 853 | 464 |
| med-guidance | 914 | 549 |
| lg-e-guidance | 1041 | 568 |
| lg-guidance-step | 1208 | 726 |
| sm-trainingfree | 1354 | 799 |
| lg-guidance | 1472 | 892 |
| med-trainingfree | 2157 | 1251 |
| lg-e-trainingfree | 2452 | 1422 |
| lg-trainingfree | 3456 | 2039 |

The Ig-guidance-step model provides a compromise between inference time and quality, while heavily-distilled smaller models may have more frequent artifacts and worse motion. More expensive models had slightly better motion, but at a heavy computational cost. Models with only training-free optimizations were most faithful to the original model, but still significantly slower than the distilled models.

### Evaluation

In order to evaluate the quality of the model, an annotation guideline may be provided to preform standalone evaluations for the different versions of a model, such as an animated sticker model. Standalone evaluations may show the annotators one animated sticker, and the annotation guideline provides questions to evaluate animated stickers based on motion quality and prompt similarity. Annotators may be instructed to place a stronger focus on certain features, such as motion quality.

Examples of motion quality tasks may include any combination of the following questions pertaining to the motion in the animated sticker:
(1) Existence: Is there any motion in the animated sticker?
(2) Relevance: Is the motion in the animated sticker expected and relevant to the prompt?
(3) Consistency: Do the characters and objects remain in proportion and consistent throughout the animation?
(4) Distortions: Is the animated sticker free of any flicker or distortion?
(5) Motion curves: Does the animation utilize smooth motion curves that reference real physics/gravity?
(6) Outline: Does the linework/white outline of the sticker move with the motion of the sticker?
(7) Looping: Does the animation play in a continuous loop?
(8) Clipping: Are there no integral elements of the animated sticker clipped?
(9) Expression: Are the expressions in the animated sticker clear?
(10) Background: Does background motion complement and not distract from the primary animation?

For each question, annotators may select “yes” or one or more reasons why the animated sticker failed.

The prompt similarity task may provide questions pertaining to how well the animated sticker matches the prompt. Such questions may include, for example:
(1) Subjects: Does the animated sticker clearly represent all subjects or objects intended in the prompt?
(2) Actions: Does the animated sticker effectively depict all specific actions or movements, as stated in the prompt?
(3) Composition: Does the animated sticker depict the desired arrangement and quantity of the subjects or objects specified in the prompt?
(4) Attributes: Does the animated sticker include all attributes (e.g., colors, shapes, sizes) and emotions of subjects or objects specified in the prompt?

Similar to the motion quality task, the annotators may be select “yes” or one or more reasons why the animated sticker failed. Annotators may also be instructed to fail the animated sticker if one of the frames failed for the question.

Table 3 shows standalone evaluation results with three annotator multi-review for an optimized student model. Some of the criteria, such as existence and relevance, have high pass rates because the guidelines for these criteria were not strict. For example, the raters were asked to choose “yes” for the existence of motion as long as there was primary motion in the sticker, which is defined as the main movement in the animation. The animated sticker did not need to have secondary motion, which are animation that amplifies the action by supporting the primary motion with secondary characteristic detail, in order to pass. However, if the guidelines are optionally tightened and require both primary and secondary motion, the pass rate may fall to 0.857.

It was also observed that distortions and consistency may have the lowest pass rate out of all of the criteria. This may be due to more motion having a larger chance of having distortions and less consistency, which lead to a lower pass rate.

TABLE 3

| Category | Consensus count | Pass rate |
|---|---|---|
| Existence | 1890 | 0.969 |
| Relevant | 1928 | 0.992 |
| Consistency | 1772 | 0.786 |
| Distortions | 1800 | 0.673 |
| Motion curves | 1888 | 0.934 |
| Outline | 1894 | 0.920 |
| Looping | 1894 | 0.999 |
| Clipping | 1894 | 0.994 |
| Expression | 1894 | 0.954 |
| Background | 1928 | 0.999 |

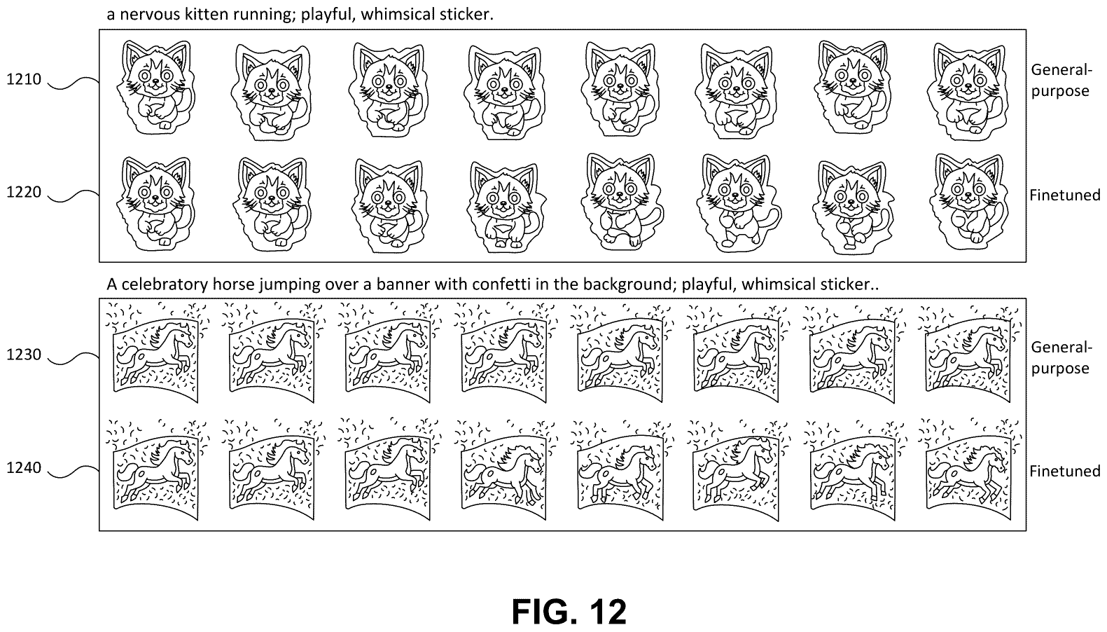

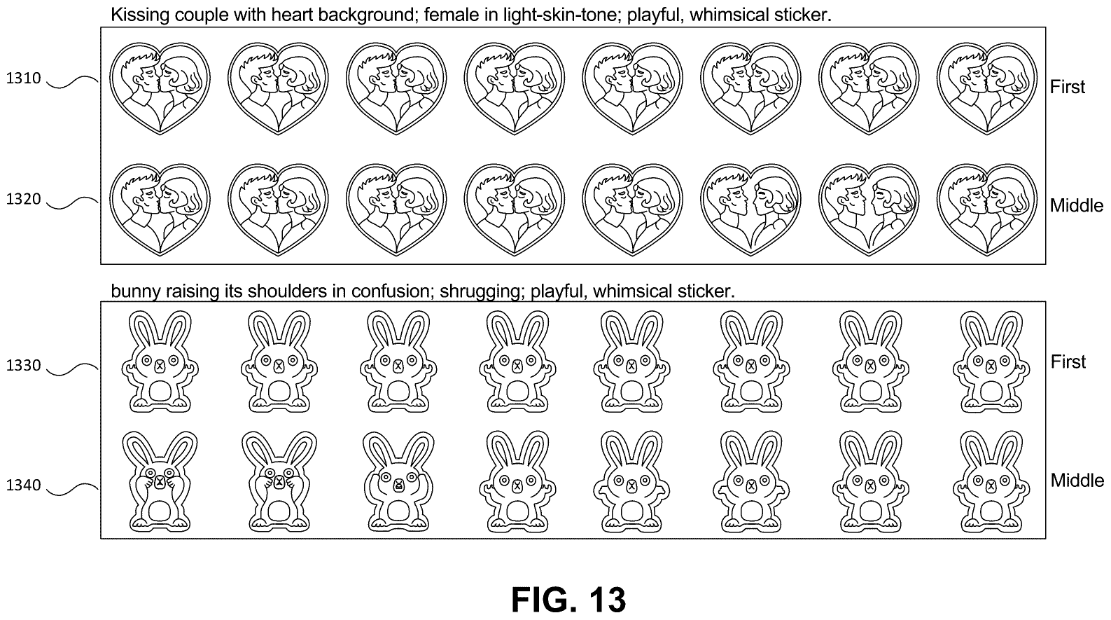

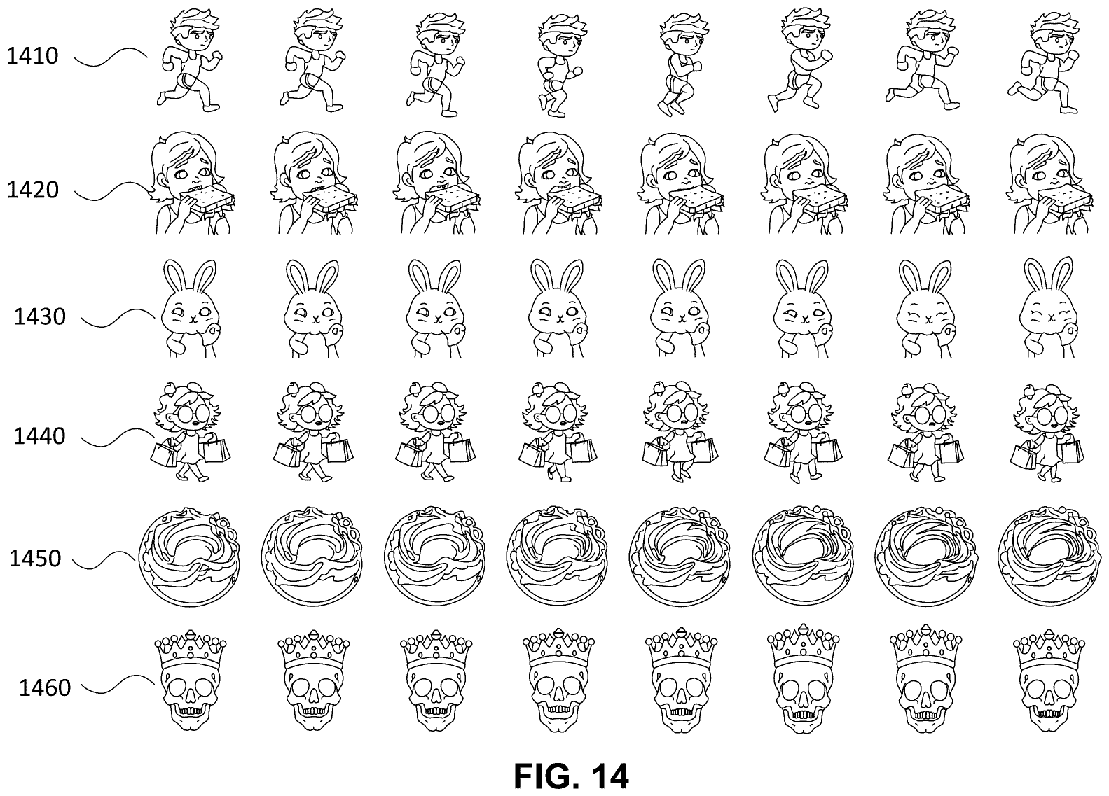

FIGS. 12, 13 and 14 illustrate example results of animated stickers generated using various improvement methods. FIG. 12 illustrates differences between pretrained and finetuned models. FIG. 13 illustrates differences between first frame conditioning and middle-frame conditioning. FIG. 14 illustrates additional animated sticker examples generated by the optimal students model.

As noted above, FIG. 12 provides examples showing the effect of finetuning (e.g., animation sets 1220, 1240) versus a general-purpose (out-of-domain) video model trained on natural videos (e.g., animation sets 1210, 1230). In-domain and HITL finetuning has the effect of (a) increasing secondary motion (e.g., in faces, background objects, etc.); (b) Giving the subject a relevant animation rather than adding a bulk motion; and (c) reducing motion artifacts. Images are shown with original (RGB) background.

In order to demonstrate the significant improvement in motion from in-domain and HITL fine-tuning, FIG. 12 illustrates some examples of the same image and prompt conditioning, animated with a 256p-trained general-purpose video model versus the student animated stickers model. Note that the general-purpose model is capable of correctly animating natural images.

In addition to adding motion to many stickers where the general-purpose model generates a static video, the full finetuning pipeline makes large improvements in three areas:
(1) Increasing secondary motion, for example in faces, background objects, and body parts. The general-purpose video model very rarely generates secondary motion in sticker-style videos, which reduces expressiveness.
(2) Giving the subject a relevant animation rather than bulk motion (e.g., only rotation or translation of the sticker). The HITL-finetuned model is able to correctly animate a number of actions, such as running, jumping, laughing, hugging, etc., but even when there is not full prompt-action alignment, the HITL-finetuned model tends to give the subject correct and relevant motion relative to itself (e.g., limbs and faces moving correctly relative to the body).
(3) Reducing motion artifacts, such as morphing and blurring.

FIG. 13 illustrates examples showing the difference between training using the first frame as conditioning (e.g., animation sets 1310, 1330) and using the middle (e.g., fourth) frame as conditioning (e.g., animation sets 1320, 1340). In general, animation sets 1310, 1320 show a kissing couple with a heart background, and animation sets 1330, 1340 show a bunny raising their shoulders, shrugging in confusion. As shown in the examples, middle-frame conditioning tends to produce larger motion, since the action in the prompt generally produces a static sticker which depicts the middle of the action rather than the beginning. Images are shown with original (RGB) background.

To highlight the effects of middle-frame conditioning, two trained models are compared: (i) a first model, pretrained on natural videos and then finetuned on the artist sticker set using first frame conditioning for both pretraining and finetuning; and (ii) a second model with the same pipeline but using middle-frame conditioning for both. FIG. 13 shows some comparisons between the two models. In general, both motion consistency and size are found to have improved with middle-frame conditioning. In the examples in FIG. 13, both cases show larger and more natural motion for middle-frame conditioning, where first-frame conditioning only shows some “bobbing” motion.

FIG. 14 illustrates additional examples of animated stickers generated by the optimized, HITL-finetuned model. Animated sets 1410, 1420, 1430, 1440, 1450, 1460 illustrate examples which had motion which was more obvious when viewed as a series of images. Images are shown with transparent regions replaced by a white background. These additional examples of animated stickers generated by the optimized student model. Examples were selected which had motion that was more visible when viewed as a sequence of images. In some aspects, the computer system of the present application may generate the animated sets 1410, 1420, 1430, 1440, 1450, and/or 1460. In some other aspects, the machine learning model of the present application may perform or facilitate generation of one or more of the animated sets 1410, 1420, 1430, 1440, 1450, and/or 1460.

Various aspects, examples, and techniques discussed herein may utilize one or more machine learning models such as neural networks, deep learning models, and other techniques such as object recognition, and/or the like, to assist in one or more of training processes, image detection, analysis, sticker generation, etc., e.g., based on data from one or more images, videos, stickers, and/or the like. Such machine learning models may be trained on data sets, such as images, videos, stickers, other domains, and/or the like.

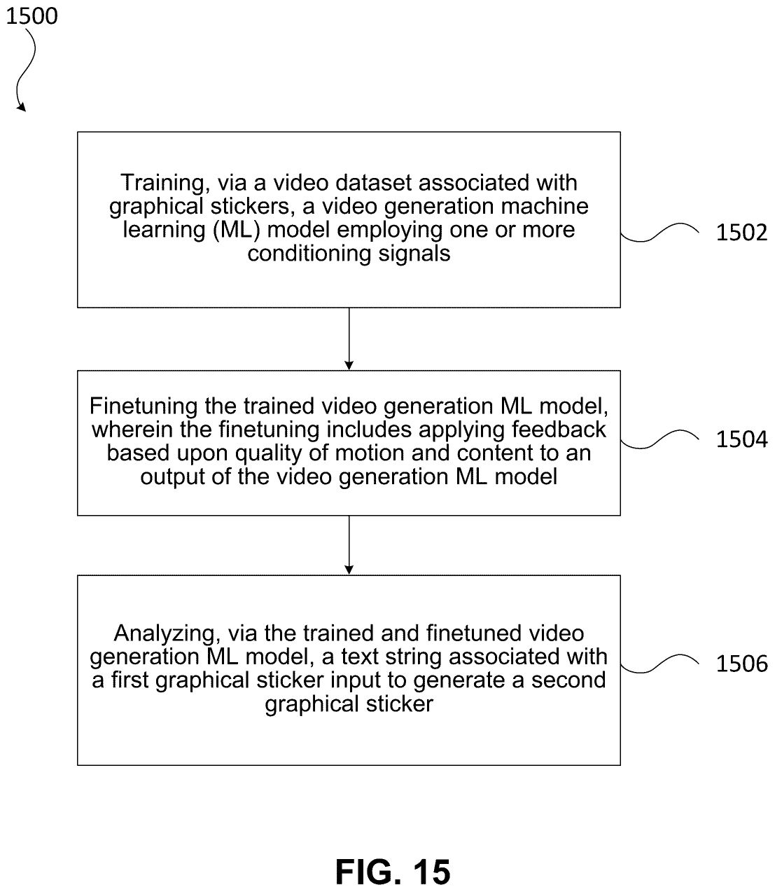

FIG. 15 illustrates an example method 1500 for implementing and operating a video generation model in accordance with aspects discussed herein (e.g., the model illustrated in FIG. 9). At block 1502, aspects may train a video generation model using a first video set and a dataset associated with a first domain. Image conditioning and text conditioning (e.g., attention block 925, conv. block 935) may be applied, as discussed herein. An example domain may be stickers, such as for example animated stickers, images, animations, videos, and the like. At block 1504, aspects may finetune the video generation model based on user input. As discussed herein, finetuning may include any of a plurality of approaches, including HITL (e.g., annotations; see FIG. 10), various student/teacher models (see, e.g., FIG. 11), prompt conditioning, middle frame conditioning, FPS bucketing and other models to, for example, improve motion quality, relevance, and video-specific train-time improvements. At block 1506, aspects may apply the video generation model to analyze a text string (e.g., text string 970) and generate an output (e.g., output 990) within the first domain. Such aspects thereby enable end-to-end process for creating, training, finetuning, or optimizing a domain-specific generative video model. In some other aspects, the machine learning model of the present application may perform one or more of the operations of blocks 1502, 1504, and/or 1506. In some aspects, the computer system of the present application may perform one or more of the operations of blocks 1502, 1504, and/or 1506.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
obtaining digital audio data associated with an audio signal from a user equipment of a user;
determining, via a trained machine learning (ML) model including one or more neural networks, an indication associated with the digital audio data, wherein the indication is selected from any one or more of a prediction of an ending of one or more portions of the digital audio data, an intention of the digital audio data, a key term of the digital audio data, an action to take in view of the digital audio data, or context associated with the digital audio data;
generating a response based upon the determined indication associated with the digital audio data; and
transmitting the response to the user equipment of the user.

2. The method of claim 1, further comprising:
determining a latency associated with generating the response, wherein the latency exceeds a predetermined threshold.

3. The method of claim 2, further comprising:
sending, to the user based upon the latency, a masking phrase or term prior transmitting the generated response.

4. The method of claim 1, further comprising:
predicting one or more responses to the predicted ending of the one or more portions of the digital audio data.

5. The method of claim 4, further comprising:
comparing the one or more predicted responses to an entire content of the digital audio data, and
selecting an optimal response from the one or more predicted responses, wherein the optimal response is the transmitted response.

6. The method of claim 1, wherein the predicted ending is based upon one or more of a word, context, pitch or tone associated with the user of the digital audio data.

7. The method of claim 1, wherein the generated response is based upon a synthesis of two or more of the determined indications.

8. The method of claim 1, wherein each neural network of the ML model is trained on a phoneme.

9. The method of claim 1, wherein the user equipment includes any one or more of a smartphone, laptop, tablet, wearable device.

10. A system comprising:
one or more processors; and
at least one memory storing instructions, that when executed by the one or more processors, cause the system to:
obtain digital audio data associated with an audio signal from a user equipment of a user;
determine, via a trained machine learning (ML) model including one or more neural networks, an indication associated with the digital audio data, wherein the indication is selected from any one or more of a prediction of an ending of one or more portions of the digital audio data, an intention of the digital audio data, a key term of the digital audio data, an action to take in view of the digital audio data, or context associated with the digital audio data;
generate a response based upon the determined indication associated with the digital audio data; and
transmit the response to the user equipment of the user.

11. The system of claim 10, wherein the instructions that when executed by the one or more processors, cause the system to determine a latency associated with generating the response, wherein the latency exceeds a predetermined threshold.

12. The system of claim 11, wherein the instructions that when executed by the one or more processors, cause the system to send, to the user based upon the latency, a masking phrase or term prior transmitting the generated response.

13. The system of claim 10, wherein the instructions that when executed by the one or more processors, cause the system to predict one or more responses to the predicted ending of the one or more portions of the digital audio data.

14. The system of claim 13, wherein the instructions that when executed by the one or more processors, cause the system to:
compare the one or more predicted responses to an entire content of the digital audio data, and
select an optimal response from the one or more predicted responses, wherein the optimal response is the transmitted response.

15. The system of claim 10, wherein the predicted ending is based upon one or more of a word, context, pitch or tone associated with the user of the digital audio data.

16. The system of claim 10, wherein the generated response is based upon a synthesis of two or more of the determined indications.

17. A method comprising:
training, via a video dataset associated with graphical stickers, a video generation machine learning (ML) model employing one or more conditioning signals;
finetuning the trained video generation ML model, wherein the finetuning includes applying feedback based upon quality of motion and content to an output of the video generation ML model; and
analyzing, via the trained and finetuned video generation ML model, a text string associated with a first graphical sticker input to generate a second graphical sticker.

18. The method of claim 17, wherein the first and second graphical stickers include any one or more of animated stickers, images, animations or videos.

19. The method of claim 17, wherein the video generation ML model employs image and text conditioning signals.

20. The method of claim 19, wherein the second graphical sticker exhibits greater motion consistency than the first graphical sticker based upon a motion conditioning signal.
